(19) United States
(12) Patent Application Publication
(10) Pub. No.: US 2022/0400017 A1
(43) Pub. Date: Dec. 15, 2022

(54) Grinding Resistant Cryptographic Systems and Cryptographic Systems Based on Certified Miners

(71) Applicant: Artema Labs, Inc, Los Angeles, CA (US)

(72) Inventor: Bjorn Markus Jakobsson, Portola Valley, CA (US)

(73) Assignee: Artema Labs, Inc, Los Angeles, CA (US)

(21) Appl. No.: 17/806,725

(22) Filed: Jun. 13, 2022

Related U.S. Application Data
(60) Provisional application No. 63/210,037, filed on Jun. 13, 2021.

(51) Int. Cl. H04L 9/32

(52) U.S. Cl. CPC H04L 9/3271; H04L 9/3247; H04L 2209/603

(57) ABSTRACT

Certified miners can be miners associated with certified public identifiers. In some embodiments, the certified public identifiers can be associated with a Trusted Execution Environment (TEE). In several embodiments mining can be based on a quality function. In various embodiments, to reduce grinding, the challenge can be based on an already closed collection of ledger entries. A device can be configured to close a ledger maintained by a cryptographic system. In an embodiment, the device includes a network interface, memory, and a processor configured to obtain a challenge using a cryptographic system, wherein the challenge is based on a closed collection of ledger entries on a ledger, to determine a quality value based on the challenge and a value; and to transmit a mining attempt to securely close a second collection of ledger entries on the ledger. The mining attempt is capable of being validated by using the cryptographic system.

### CROSS-REFERENCE TO RELATED APPLICATIONS

The current application claims the benefit of and priority under 35 U.S.C. § 119(e) to U.S. Provisional Patent Application No. 63/210,037 entitled “Improved Coin Technology” filed Jun. 13, 2021, the disclosure of which is hereby incorporated by reference in its entirety for all purposes.

### FIELD OF THE INVENTION

This invention relates to cryptography. More particularly it relates to cryptographic systems for maintaining distributed ledgers.

### BACKGROUND OF THE INVENTION

Cryptography can be used to provide security, privacy and authenticity to transactions. Some cryptographic components, such as digital signatures and encryption functions, are standardized and well-studied with known security characteristics. Cryptography can be used to create immutable ledgers such as (but not limited to) blockchains. Immutable ledgers and blockchains can be based on a variety of cryptographic methods. In some implementations of immutable ledgers and blockchains, mining is used to securely add information. Mining can include computer systems (often referred to as “miners”) generating proofs based on computational challenges. Generally, a proof can be an output of a function that conforms to one or more requirements defined by a challenge. A proof protocol can be a function used to generate a proposed proof. The proof protocol can be iteratively performed until a proof is generated which meets the requirements of the challenge. The requirements of the challenge can be based on a difficulty. Mining can also include the use of computer systems known as “verifiers” that perform processes to check the generated proofs. In many instances, a proof can be easily verified based on providing successful inputs to a verifier. Miners and verifies can be implemented using any one or more of personal computers, application-specific integrated circuits, mobile devices (e.g. a mobile phone or tablet), server computer systems, virtual machines executing on computer systems, and/or any other form of computing device capable of performing computations associated with the performance of a particular mining or verifier function.

In a traditional blockchain based payment, a payer receives a public key from a payee and generates a digital signature on a message that includes the received public key. This enables the holder of the associated private key, namely the payee, to use the generated digital signature and the private key associated with the signed public key to spend money according to the same technique as the payer used to transfer funds to the payee. In traditional systems, a token (e.g. a fungible token) can be transferred to multiple payees (e.g. transfer ⅓ of token to a payee and ⅔ of a token to a second payee (e.g. the payer). Traditionally, non-fungible token, cannot be transferred in part, so there can only be one recipient.

### SUMMARY OF THE INVENTION

A device can be configured to close a ledger maintained by a cryptographic system. In an embodiment, the device includes a network interface, memory, and a processor. The processor configured to obtain a challenge using a cryptographic system, wherein the challenge is based on a first collection of ledger entries on a ledger, the first collection of ledger entries closed based on a first mining attempt, determine a quality value based on the challenge and a value, and, transmit a second mining attempt to securely close a second collection of ledger entries on the ledger. The second mining attempt is capable of being validated by using the challenge and the cryptographic system.

In another embodiment, the value is a public identifier.

In a further embodiment, the value is a public key.

In still another embodiment, the mining attempt comprises a digital signature, the digital signature generated using a private key, the private key corresponding to the public key.

In a still further embodiment, a private key is associated with the public key and the private key is stored in a secure storage associated with a Trusted Execution Environment.

In yet another embodiment, a private key is associated with the public key and the private key is associated with a certified Digital Rights Management system.

In another additional embodiment, the mining attempt comprises a delay function result.

In a further additional embodiment, the delay function result is a proof of work.

In another embodiment again, the mining attempt is capable of being validated by using the value.

In a further embodiment again, the processor is further configured to generate a challenge using a cryptographic system, wherein the challenge is based on a closed collection of ledger entries on a ledger.

In still yet another embodiment, the challenge is a hash of at least the first collection of ledger entries and the quality value is based on a hamming distance between the challenge and the public key.

In still another additional embodiment, the challenge is based on a most recently closed collection of ledger entries.

A device can be configured to close a ledger maintained by a cryptographic system. In an embodiment, the device includes a network interface, memory, and a processor. The processor configured to obtain a mining attempt comprising a digital signature, the digital signature generated using a private key associated with a public key, to determine a quality value based on the public key and a challenge, and to transmit the mining attempt to securely close a collection of ledger entries on the ledger. The mining attempt is capable of being validated based on the quality value and the public key.

In another embodiment, the mining attempt further includes a delay function result.

In a further embodiment, the delay function result is a proof of work.

In still another embodiment, the challenge is based on a closed collection of ledger entries.

In a still further embodiment, the mining attempt includes a digital signature, the digital signature generated using a private key, the private key corresponding to the public key.

In yet another embodiment, the private key is stored in a secure storage associated with a Trusted Execution Environment.

In another additional embodiment, the private key is associated with a certified Digital Rights Management system.

In a further additional embodiment, the challenge is based on a most recently closed collection of ledger entries.

A device can be configured to close a ledger maintained by a cryptographic system. In an embodiment, the device includes a network interface, memory, and a processor. The processor configured to obtain a challenge using a cryptographic system, wherein the challenge is based on a closed collection of ledger entries on a ledger, to determine a quality value based on the challenge and a value; and to transmit a mining attempt to securely close a second collection of ledger entries on the ledger. The mining attempt is capable of being validated by using the cryptographic system.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention

FIGS. 10-12 depict various devices that can be utilized alongside an NFT platform in accordance with various embodiments of the invention.

FIG. 13 depicts a media wallet application configuration in accordance with an embodiment of the invention.

FIGS. 14A-14C depict user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example process for generating a mining attempt based on a certified public identifier.

FIG. 19 conceptually illustrates an example process for verifying a mining attempt based on a certified public identifier.

FIG. 20 conceptually illustrates an example process for generating a mining attempt based on a public identifier and a challenge for grinding avoidance.

FIG. 21 conceptually illustrates an example of a process for generating a metric associated with a cryptographic system.

FIG. 22 conceptually illustrates an example mining platform that provides resource information to a requestor prior to initiating a mining operation.

FIG. 23 conceptually illustrates an example mining platform that provides resource information to a requestor prior to the requestor approving a mining operation.

FIG. 24 conceptually illustrates an example process for generating a mining attempt based on a public identifier and a received graph.

FIG. 25 conceptually illustrates an example process for the committing of payment for the outsourced generation of a graph using a fair exchange mechanism.

### DETAILED DESCRIPTION

Turning now to the drawings, cryptographic systems based on certified miners in accordance with various embodiments of the invention are illustrated. Certified miners can be miners associated certified public identifiers. In some embodiments, the certified public identifiers can be public identifiers (e.g. public keys) associated with a Trusted Execution Environment (TEE), a Digital Rights Management (DRM) System, or another resource that can be directly associated with a device (e.g. a cell phone). In several embodiments mining can be based on a quality function. The quality function can be based on a comparison between a challenge and a public key. Using a quality function based on a comparison between a public key and a challenge can be very energy efficient since large numbers of calculations may not be necessary. In various embodiments, to reduce grinding, the challenge can be based on an already closed collection of ledger entries. This prevents abusers from adding ledger entries to improve their chance of generating a successful mining attempt.

In many embodiments, cryptographic systems based on certified miners can be implemented within blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

Existing cryptocurrency solutions, such as Bitcoin and Ethereum, demand a tremendous amount of energy as a result of the proof-of-work consensus algorithms. In some embodiments, one or more computing elements (e.g. mining supervisors) are capable of monitoring the various requests for mining and the available mining supplies. These elements can also monitor the various costs of mining which may include (but are not be limited to) electrical energy costs, equipment cooling costs, and political costs based on generating metrics. Political costs can include mining in undesirable foreign countries or with highly centralized systems that users may perceive as harming the intent of what is designed to be a highly decentralized cryptocurrency system. Users can base decisions, manually or automatically on the information provided by the mining supervisors.

Several cryptosystems, such as the system described in U.S. Provisional Patent Application No. 62/812,901 titled “Fair and Affordable Mining” by Bjorn Markus Jakobsson; in the Chia™ cryptosystem, as described on https://www.chia.net/faq/; and the BurstCoin™ cryptographic system, address energy efficiency; all of these documents are incorporated by reference. However, one aspect that is common for all of these cryptosystems is that they are associated with a substantial initial energy cost, associated with the setup of a particular miner.

The initial energy cost can be associated with the computation of a graph comprising a set of nodes and edges. The graph can be later used to generate responses to challenges. A mining instance (also referred to as a mining attempt, or mining solution) can be associated with the graph. A mining instance can be associated with an identifier that is used for registration of the graph.

In a number of embodiments, the generation of a graph is at least in part outsourced by a miner (e.g. a miner process executed by a system), to a generator (e.g. a generator process executed by a system) that can compute the graph in a more efficient or less costly manner than the miner. In several embodiments, the graph is rendered usable only by the requesting miner by generating the graph based on a private key associated with the requesting miner. Moreover, a miner and a generator that do not trust each other with the exchange of the graph for the payment of the graph can use an exchange mechanism. Suitable exchange mechanisms are described herein. In various embodiments, the exchange mechanism described can be used for a fair exchange in the context disclosed herein, including for use as a payment for outsourced generation of graphs and for purposes of exchanging payments for contracts without the need for any trust.

Cryptographic systems, certified miners, and processes utilized to efficiently generate graphs for the purposes of performing energy efficient cryptographic processes in accordance with various embodiments of the invention are discussed in detail below. While cryptographic systems are not limited to use in blockchain-based non-fungible (NFT) platforms, blockchain-based non-fungible (NFT) platforms that can include the cryptographic systems described herein are introduced below as an illustrative example of the manner in which cryptographic systems in accordance with various of the embodiments of the invention can be implemented within blockchain-based systems.

### Blockchain-Based NFT Platforms

In a number of embodiments, content creators can issue NFTs to users within a blockchain based NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

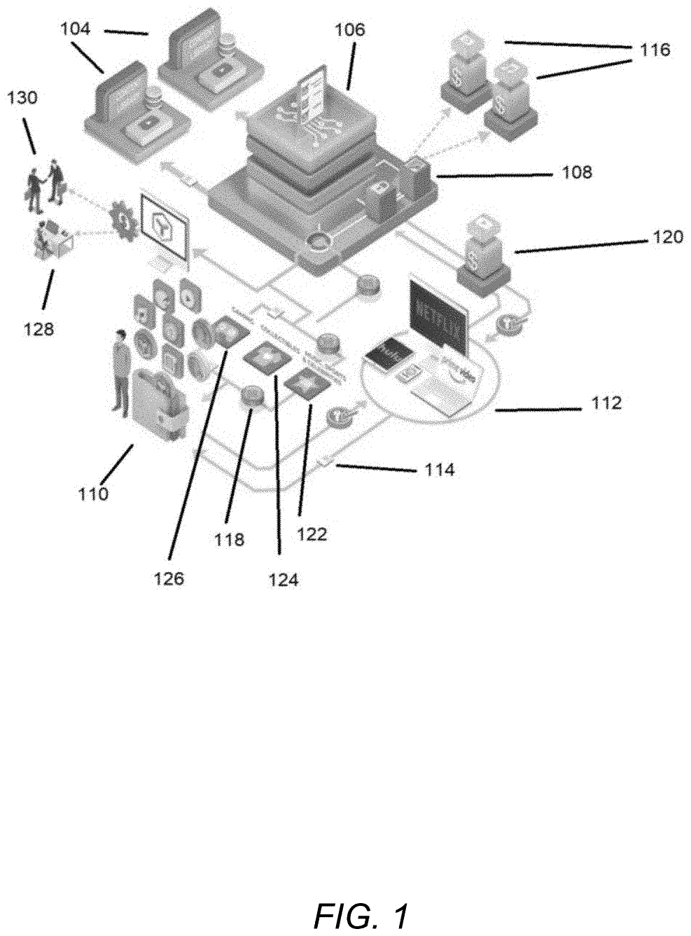

An NFT platform in accordance with an embodiment of the invention is illustrated in FIG. 1. The NFT platform 100 utilizes one or more immutable ledgers (e.g. one or more blockchains) implemented using one or more of the cryptographic systems described herein to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

As illustrated in FIG. 1, users can install the media wallet application 110 onto their devices and use the media wallet application 110 to purchase fungible tokens. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

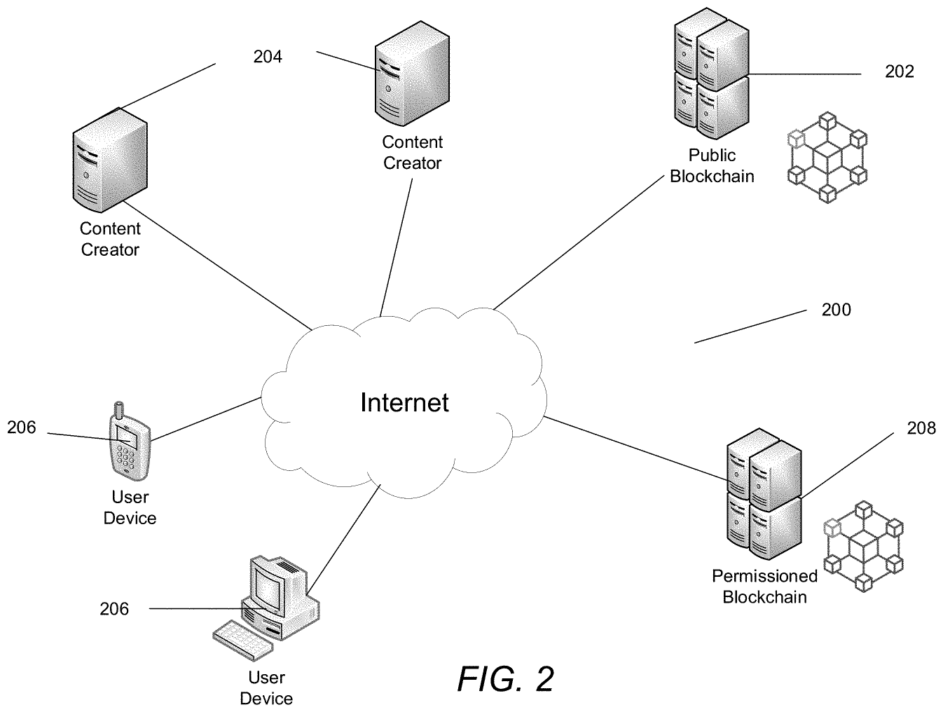

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

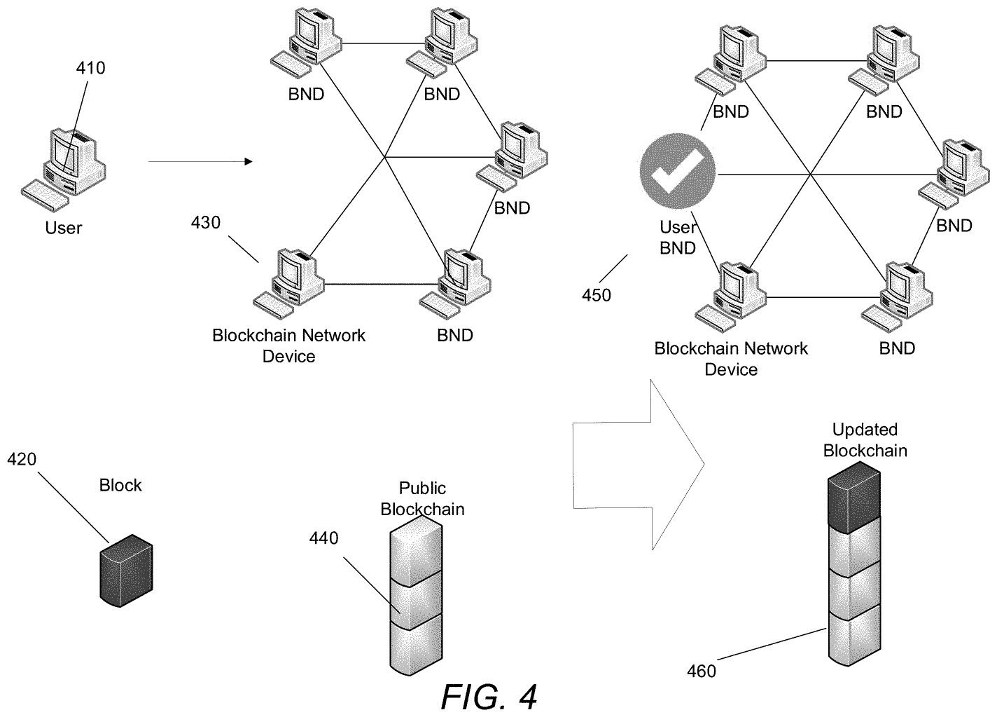

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, proof of stake, etc.). A number of consensus mechanisms in accordance with various embodiments of the invention are discussed further below.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

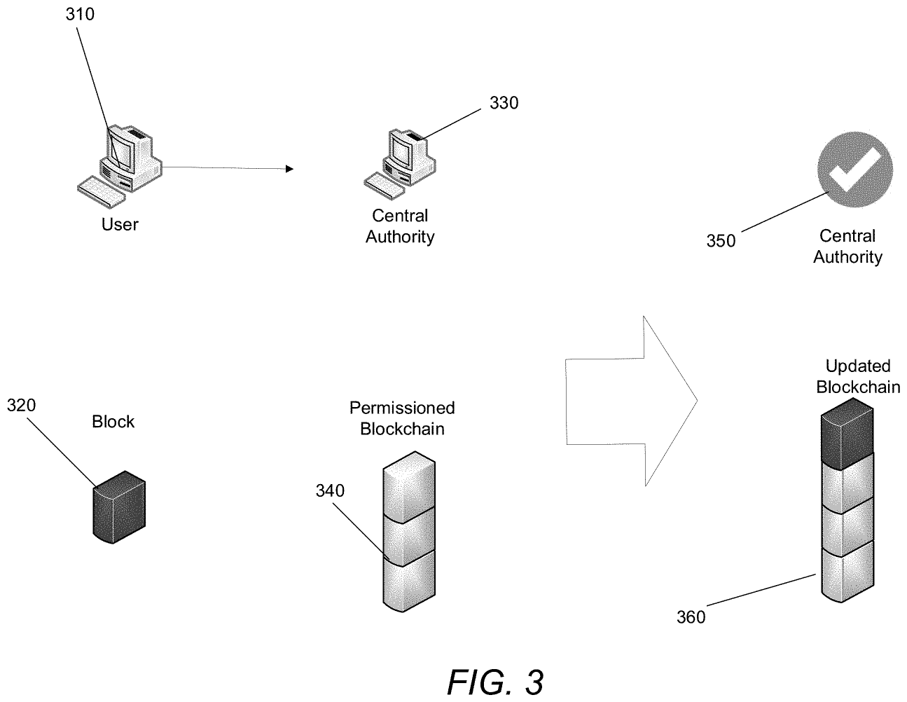

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

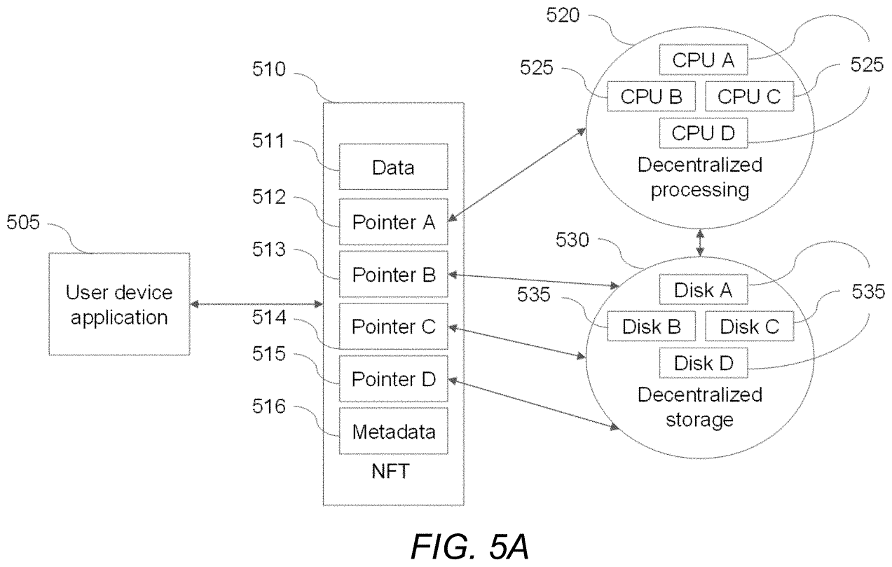

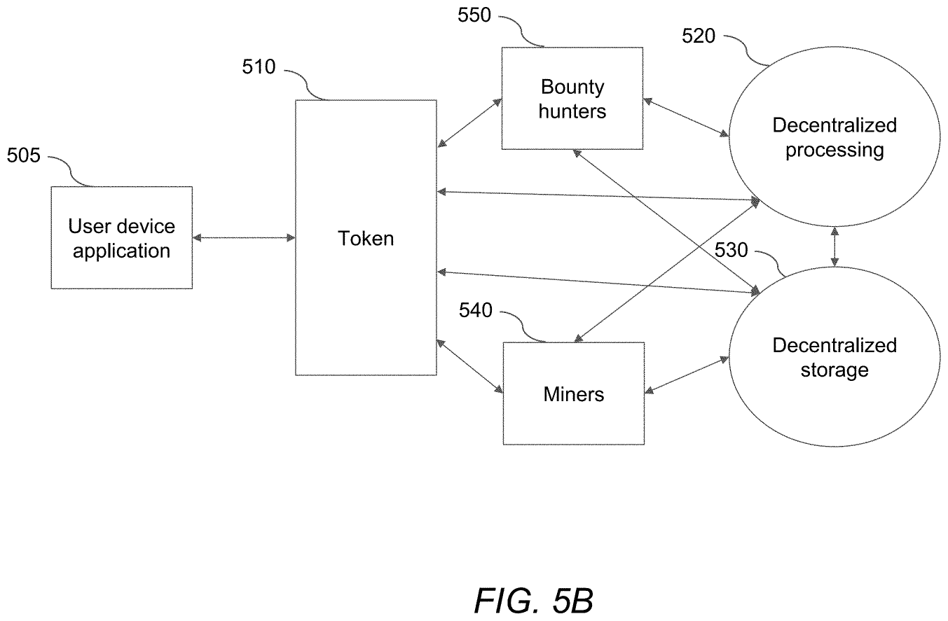

Systems and processes in accordance with certain embodiments of the invention can incorporate methods for detection of abuse, essentially a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

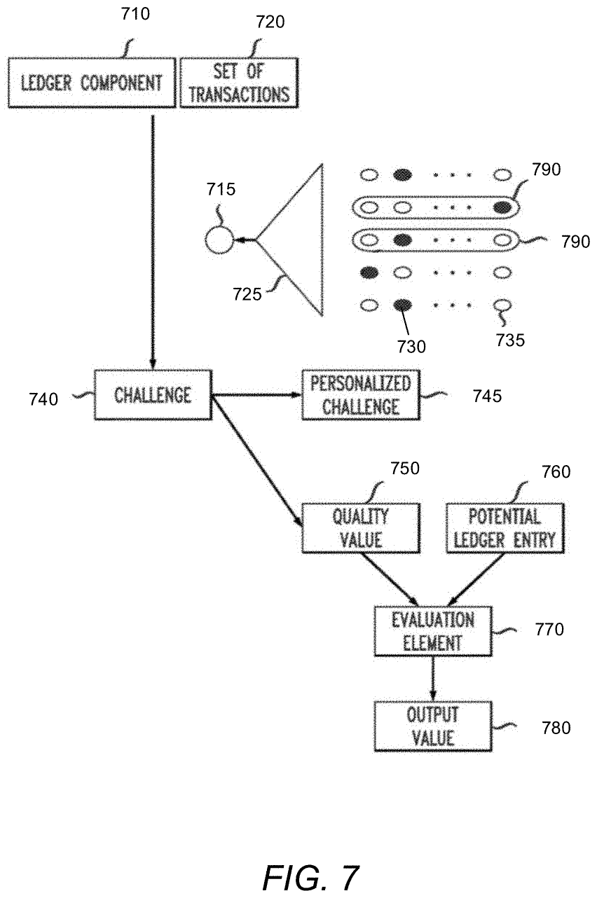

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

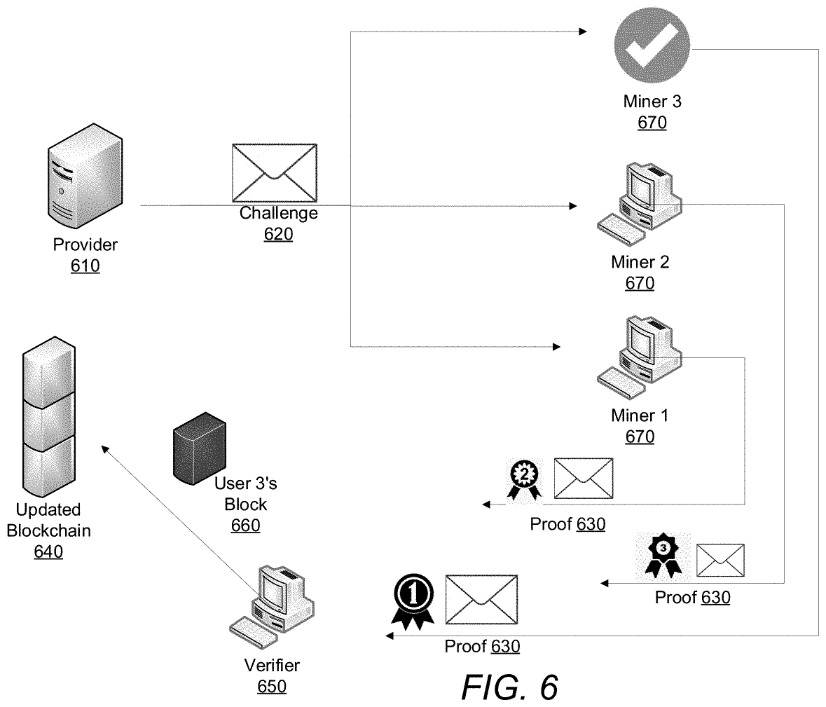

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

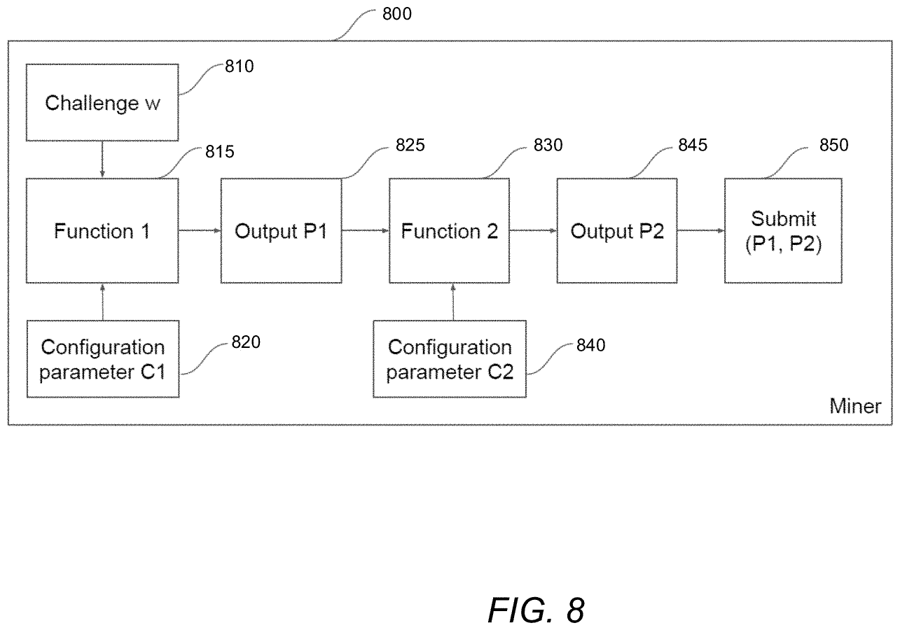

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also operate as public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, proof of stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

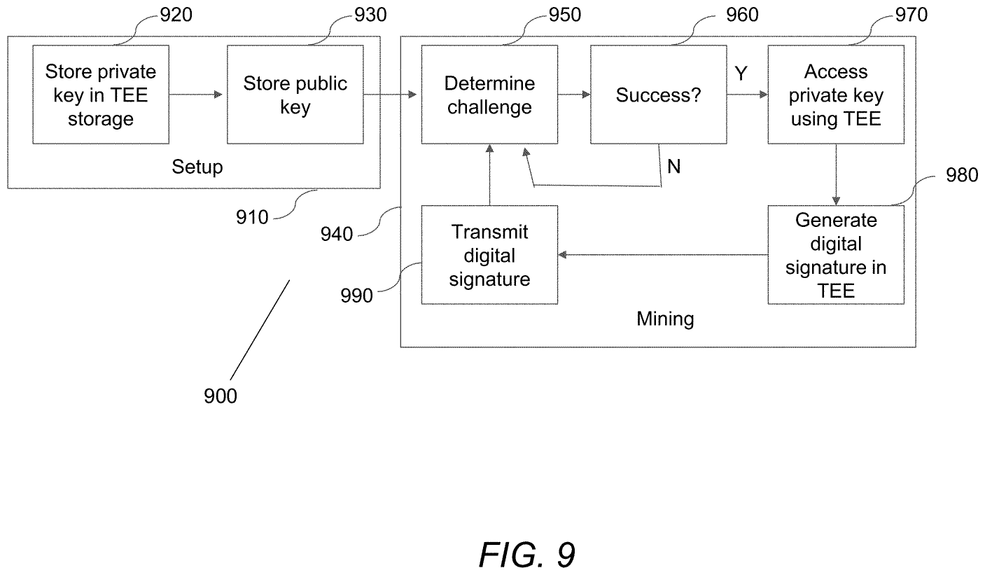

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

### Cryptographic System Based on Certified Miners

In various embodiments a cryptographic system can be based on certified miners. Certified miners can be miners associated certified public identifiers. In some embodiments, the certified public identifiers can be public identifiers (e.g. public keys) associated with a Trusted Execution Environment (TEE), a Digital Rights Management (DRM) System, or another resource that can be directly associated with a device (e.g. a cell phone). In several embodiments mining can be based on a quality function. The quality function can be based on a comparison between a challenge and a public key. Using a quality function based on a comparison between a public key and a challenge can be very energy efficient since large numbers of calculations may not be necessary. In various embodiments, to reduce grinding, the challenge can be based on a already closed collection of ledger entries.

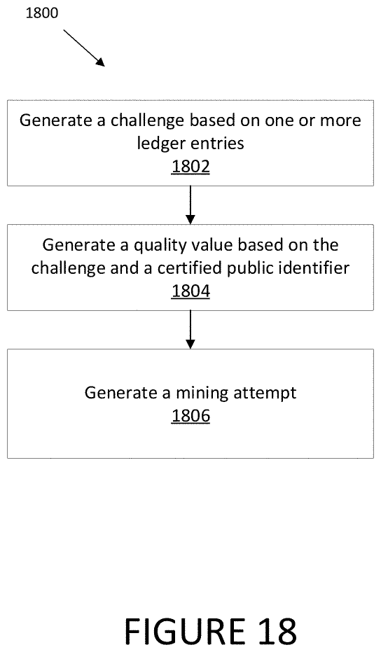

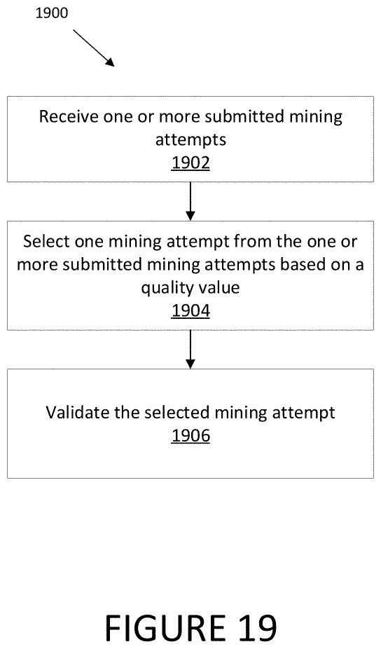

An example process for generating a mining attempt based on a certified public identifier is conceptually illustrated in FIG. 18. In several embodiments, processes for generating a mining attempt based on a certified public identifier can be executed by a miner. Relatedly, an example process for verifying a mining attempt based on a certified public identifier is conceptually illustrated in FIG. 19 In many embodiments, processes for verifying a mining attempt based on a certified public identifier can be executed by a verifier. In several embodiments a verifier can be a miner.

Process 1800 can generate (1802) a challenge based on one or more ledger entries. A quality value can be generated (1804) based on the challenge and a certified public identifier. The certified public identifier can be a public key associated with a private key that is stored in a Trusted Execution Environment (TEE), a Digital Rights Management (DRM) System, or another resource that can be directly associated with a device (e.g. a cell phone). Based on the quality value and the certified public identifier a mining attempt can be generated (1806).

Process 1900 can receive (1902) one or more mining attempts. Based on quality values associated with the one or more mining attempts the process 1900 can select (1904) one mining attempt. The selected mining attempt can be validated (1906) by the process 1900. The selected mining attempt can be used to close the ledger.

In many embodiments, a cryptographic system can be based on a Trusted Execution Environment (TEE) (e.g. ARM TrustZone™, or Intel SGX™) as previously described. In certain embodiments each TEE, or alternative, can be associated with a public identifier (e.g. a public key) and an associated private key. The private key can be used for signing messages. The private key can be stored in a secure storage associated with the TEE. In many embodiments, the public identifier (e.g. public key) is certified. The public identifier can be certified by a manufacturer, Original Equipment Manufacturer (OEM), or a distributor with an influence over the manufacturing and configuration process of the TEE.

In certain embodiments, a process generates a challenge based at least in part on one or more ledger entries. In some embodiments, a time-lag function can be used to compute the challenge from a set of ledger entries received in a time interval. The time interval can be the time between two previous successful ledger closings. The successful ledger closings can be by means of mining. A consensus mechanism can be used to determine which ledger entries fall between the two ledger closings. A consensus mechanism can determine the ledger entries falling between the two ledger closing according to a rule. The rule can be a rule made available to all miners associated with a cryptographic system. In various embodiments, the use of ledger entries logged in a previous time interval can reduce the susceptibility of the cryptographic system to grinding (a process in which a party attempts to affect a challenge in order to alter the odds of successfully mining). Reducing susceptibility to grinding is further discussed herein.

In some embodiments, a process can determine whether the configuration associated with a TEE meets a criterion. The criteria can correspond to success or likely success of mining. In various embodiments, a challenge can be compared with a portion of a public identifier (e.g. public key) associated with a TEE.

In various embodiments, a quality value can be computed based on the comparison of the challenge to the public identifier. For example, the quality value may indicate a distance from a public identifier (e.g. public key) portion to a challenge. The quality value can be a value based on the public identifier and the challenge. In a number of embodiments, the quality value can be based on a comparison that includes computing a difference by interpreting the target value (e.g. public identifier, public key) as a first number and the challenge as a second number, and computing the difference between the first and the second number. In several embodiments, a greater difference corresponds to a higher quality value. In many embodiments, quality value can be determined based on computing the XOR of a first value (e.g. a value based on a public identifier, a value based on a public key) and a second value (e.g. a value based on a challenge). In certain embodiments, if a process generates a quality value exceeding a threshold then the process can generate a mining attempt. The process can submit the mining attempt for verification. A skilled artisan will recognize that the comparison between the public identifier and the challenge can be performed in a variety of ways, and the generation of a quality value, likewise, can be performed using one of a large variation of manners.

In several embodiments a process can receive one or more submitted mining attempts. The one or more mining attempts can be compared and, using a consensus method, a mining attempt with a preferred quality value can be selected. A preferred quality score can correspond to a greatest quality score.

In various embodiments, a mining attempt can include determining a digital signature based on the challenge. In a number of embodiments, a mining attempt can include information related to ledger entries. For example, the ledger entries can be related to a time interval. For example, the mining attempt can include a hash of the ledger entries associated with a time interval. The digital signature can be determined based on one or more public keys, as disclosed in U.S. Provisional Patent Application No. 63/208,366 titled “Perpetual NFT Assets” filed Jun. 8, 2021, which is incorporated in its entirety by reference, and as disclosed in U.S. Pat. No. 11,017,036 titled “Publicly Verifiable Proofs of Space”, which is also incorporated by reference in its entirety.

In several embodiments, a process can validate a mining attempt by determining whether a quality value associated with the mining attempt indicates that it is the preferred mining attempt. The process can select one mining attempt from one or more mining attempts based on quality values associated with the one or more mining attempts. Validating a selected mining attempt can include determining whether a public key associated with the mining attempt corresponds to a valid TEE by verifying an associated certificate on the public key. Validating the selected mining attempt can include determining whether a digital signature is a valid signature on the proper input (e.g. the appropriate ledger entries, the public key indicated in the mining attempt). The validation can be based on the certified public key.

In several embodiments, if a validation fails then the verifier can select a new mining attempt associated with the next-most preferred quality value and perform an analogous validation on that mining attempt. This process can be repeated, until a successful validation is performed for a selected mining attempt. The mining attempt can then be declared a winner by the verifier (which can also be referred to as a validator). A consensus can be achieved when a quorum of verifiers can indicate that one and the same mining attempt is the winner. In many embodiments the winning mining attempt can be used to close the ledger with respect to the entries it includes. In certain embodiments, ledger entries in the closed ledger can be fixed in their relative order with respect to ledger entries in other intervals associated with other ledger closings.

### Cryptographic System Based on Certified Miners

In various embodiments cryptographic systems in accordance with many embodiments of the invention can be based on certified miners. Certified miners can be miners associated with certified public identifiers. In some embodiments, the certified public identifiers can be public identifiers (e.g. public keys) associated with a Trusted Execution Environment (TEE), a Digital Rights Management (DRM) System, and/or another resource that can be directly associated with a device (e.g. a cell phone). In several embodiments, mining processes performed by certified miners can be based on a quality function. The quality function can be based on a comparison between a challenge and a public key. Using a quality function based on a comparison between a public key and a challenge can be very energy efficient since large numbers of calculations may not be necessary. In various embodiments, to reduce grinding, the challenge can be based on an already closed collection of ledger entries.

A process for generating a mining attempt based on a certified public identifier is conceptually illustrated in FIG. 18. In several embodiments, processes for generating a mining attempt based on a certified public identifier can be executed by a miner. Relatedly, A process for verifying a mining attempt based on a certified public identifier is conceptually illustrated in FIG. 19. In many embodiments, processes for verifying a mining attempt based on a certified public identifier can be executed by a verifier. In several embodiments a the verifier can be a miner.

Process 1800 can generate (1802) a challenge based on one or more ledger entries. A quality value can be generated (1804) based on the challenge and a certified public identifier. The certified public identifier can be a public key associated with a private key that is stored in a Trusted Execution Environment (TEE), a Digital Rights Management (DRM) System, or another resource that can be directly associated with a device (e.g. a cell phone). Based on the quality value and the certified public identifier, a mining attempt can be generated (1806).

Process 1900 can receive (1902) one or more mining attempts. Based on quality values associated with the one or more mining attempts, the process 1900 can select (1904) one mining attempt. The selected mining attempt can be validated (1906) by the process 1900. In several embodiments, tThe selected mining attempt can be used to close the ledger.

In many embodiments, a cryptographic system can be based on a Trusted Execution Environment (TEE) (e.g. ARM TrustZone™, or Intel SGX™) as previously described. In certain embodiments, each TEE, or alternative, can be associated with a public identifier (e.g. a public key) and an associated private key. The private key can be used for signing messages. The private key can be stored in a secure storage associated with the TEE. In many embodiments, the public identifier (e.g. public key) is can be certified. The public identifier can be certified by a manufacturer, Original Equipment Manufacturer (OEM), and/or a distributor with an influence over the manufacturing and configuration process of the TEE.

In certain embodiments, a process generates a challenge based at least in part on one or more ledger entries. In some embodiments, a time-lag function can be used to compute the challenge from a set of ledger entries received in a time interval. The time interval can be the time between two previous successful ledger closings. The successful ledger closings can be by means of mining. A consensus mechanism can be used to determine which ledger entries fall between the two ledger closings. A consensus mechanism can determine the ledger entries falling between the two ledger closings according to a rule. The rule can be a rule made available to all miners associated with a cryptographic system. In various embodiments, the use of ledger entries logged in a previous time interval can reduce the susceptibility of the cryptographic system to grinding (a process in which a party attempts to affect a challenge in order to alter the odds of successfully mining). Reducing susceptibility to grinding is further discussed herein.

In some embodiments, a process can determine whether the configuration associated with a TEE meets a criterion. The criteria can correspond to success or likely success of mining. In various embodiments, a challenge can be compared with a portion of a public identifier (e.g. public key) associated with a TEE.

In various embodiments, a quality value can be computed based on the comparison of the challenge to the public identifier. For example, the quality value may indicate a distance from a public identifier (e.g. public key) portion to a challenge. The quality value can be a value based on the public identifier and the challenge. In a number of embodiments, the quality value can be based on a comparison that includes computing a difference by interpreting the target value (e.g. public identifier, public key) as a first number and the challenge as a second number, and computing the difference between the first and the second number. In several embodiments, a greater difference corresponds to a higher quality value. In many embodiments, a quality value can be determined based on computing the XOR of a first value (e.g. a value based on a public identifier, a value based on a public key) and a second value (e.g. a value based on a challenge). In certain embodiments, if a process generates a quality value exceeding a threshold, then the process can generate a mining attempt. The process can submit the mining attempt for verification. A skilled artisan will recognize that the comparison between the public identifier and the challenge can be performed in a variety of ways, and the generation of a quality value, likewise, can be performed using one of a large variation of manners.

In accordance with some embodiments of the invention, at least some mining attempts of the one or more mining attempts received by a first process, can be generated by a second process using a certified DRM environment to enable a certified public identifier (e.g. public key). In some embodiments, a certifying party has certified that the DRM environment satisfies one or more criteria (e.g. such as a being the only DRM-based miner on a given physical device). The certification can be based on a heuristic evaluation of the computational environment of the device executing the DRM-based miner. A DRM-based miner can be associated with a certified public identifier (e.g. public key).

In various embodiments, all miners associated with a cryptographic system can be DRM-based miners. In several embodiments, all miners associated with a cryptographic system can be TEE-based miners. In a number of embodiments, a cryptographic system can include miners that are DRM-based miners and also TEE-based miners. In several embodiments, a first process (e.g. verification or validation processes) can only accept mining attempts from second processes (e.g. generation processes) associated with TEE-based miners. In some embodiments, a first process (e.g. verification or validation process) can accept only accept mining attempts from second processes (e.g. generation processes) associated with DRM-based miners. In certain embodiments, a first process (e.g. verification processes) can accept mining attempts from second processes (e.g. generation processes) associated with TEE-based miners and DRM-based miners.

In several embodiments, a cryptographic system can switch between one or more types of consensus mechanisms. For example, a cryptographic system can, in a first configuration use a first consensus mechanism (e.g. a consensus mechanism related to TEE-based mining only) and in a second configuration use a second consensus mechanism (e.g. a consensus mechanism related to DRM-based mining only, or related to a combination of TEE-based and DRM-based). In various embodiments a cryptographic system can automatically reconfigure from a first configuration using a first consensus mechanism to a second configuration using a second consensus mechanism.

In some embodiments a cryptographic system capable of accepting TEE-based mining and DRM-based mining can be a composite system as disclosed in co-pending application titled “Composite Cryptographic Systems with Variable Configuration Parameters and Memory Bound Functions.” In various embodiments a composite cryptographic system can include a first constituent system corresponding to TEE-based mining and a second constituent system corresponding to DRM-based mining. In a number of embodiments, a first set of verifiers can accept a first set of configurations and a second set of verifiers can accept a second set of configurations. The first set of configurations can be different from the second set of configurations. In several embodiments, each verifier can be modified at any time to change from one validation criterion to another.

In many embodiments, a limited number of TEE-based miners are assigned. In some embodiments, a limited number of DRM-based miners are assigned. For example, a total of 101 TEE-based or DRM-based miners can be assigned.

While specific miner configurations are described above, it should be readily appreciated that miners can be implemented using any of a variety of configurations including (but not limited to) TEE-based or DRM-based configurations in accordance with various embodiments of the invention. Techniques for identification of miners in accordance with certain embodiments of the invention are discussed further below.

Instead of identifying a miner based on public identifier related a TEE or a DRM, the miner can be identified based on another resource. In some embodiments, a public identifier can be directly associated with a device. In various embodiments, a public identifier can be an immutable blockchain ledger entry which can correspond to a cryptographic hash of an associated cryptographic key.

In a number of embodiments, a public identifier can be a phone number associated with a mobile device. The phone number and/or other related identifiers can be used to generate a first value. The first value can be used for comparison to a challenge. Based on the comparison of the first value to the challenge a quality value can be determined. The quality value can be tied to identifiers such as (but not limited to) a phone number and/or other related identifiers. For example, a cryptographic hash of a phone number can be used as the first value, and compared to a challenge, from which a quality value is computed. This quality value can then be tied to the phone number.

In several embodiments a mining attempt can be submitted, of the general format described above, using a public key for which the miner application knows the corresponding private key, to a bulletin board (e.g. mining pool) by transmitting an SMS from the phone, over the SMS channel associated with the phone number. An automated response including a nonce or another challenge can be received by the phone, again by SMS on the channel associated with the phone number, where knowledge of said response can be used to access a reward (e.g. transmitting a token) associated with the mining attempt.

In some embodiments, a process can relate the ledgers of two independent cryptographic systems by using the state of one cryptographic system (e.g., the value of a pre-set winning mining attempt) as an input to another cryptosystem (e.g., in the form of adding that state value to the ledger to be closed before computing the challenge).

In various embodiments, public identifiers associated with phone numbers, TEEs, DRMs, immutable blockchain ledger entries, or other devices can be used for generating quality values for use in cryptographic systems. In certain embodiments, the cryptographic system utilizes one or more of phone numbers, TEEs, DRMs, and/or immutable blockchain ledger entries for determining valid proofs.

While specific processes for generating and verifying a mining attempt based on a certified public identifier with a cryptographic system are described above, any of a variety of processes can be utilized to generate or verify a mining attempt based on a certified public identifier with a cryptographic system as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generation and verification of a mining attempt based on a certified public identifier, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, mining supervisors, metrics for cryptographic systems, and outsourcing graph generation for cryptographic systems as described elsewhere herein.

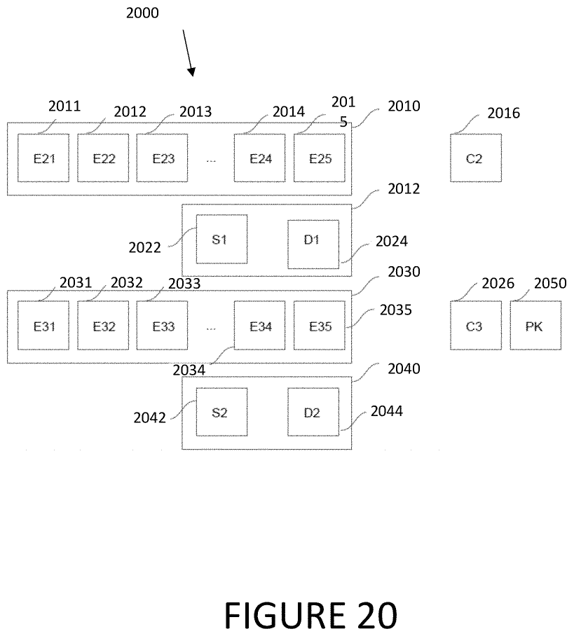

In various embodiments a mining attempt can be generated based on a challenge and a public identifier. The challenge can be based on the content of a collection of ledger entries on a ledger. The collection for generating the challenge can be selected based on being the ledger entries between two ledger closings. Generating the challenge based on the selected ledger entries can be an approach to avoid grinding. A ledger closing can be associated with a successful mining attempt. An example process for generating a mining attempt based on a public identifier and a challenge for grinding avoidance is conceptually illustrated in FIG. 20. In several embodiments, processes for generating a mining attempt based on a public identifier and a challenge for grinding avoidance can be executed by a miner.

A ledger 2000 includes a first collection 2010, a second collection 2020, a third collection 2030 and a fourth collection 2040. The fourth collection 2040 can be posted after the third collection 2030 is recorded. The third collection 2030 is recorded after the second collection 2020 is posted. The second collection 2020 can be posted after the first collection 2010 is recorded.

The first collection 2010 includes ledger entries E21 2011, E22 2012, E23 2013, E24 2014 and E25 2015. First challenge C2 2016 is based on the ledger entries in the first collection 2010. The second collection 2020 is a successful mining attempt that closes the ledger after collection 2010, thereby timestamping ledger entries E21 2011, E22 2012, E23 2013, E24 2014 and E25 2015 as having been recorded prior to the posting of the second collection 2020. Second collection 2020 includes digital signature 51 2022 and delay function result D1 2024. The third collection 2030 includes ledger entries E31 2031, E32 2032, E33 2033, E34 2034 and E35 2035. Second challenge C3 2026 is based on the ledger entries in the third collection 2030. The fourth collection 2040 is a successful mining attempt that closes the ledger after the third collection 2035, thereby timestamping ledger entries E31 2031, E32 2032, E33 2033, E34 2034 and E35 2035 as having been recorded prior to the posting of collection 2040 but after collection 2010. The fourth collection 2410 includes digital signature S2 2042 and optional delay function result D2 2044. The digital signature S2 2042 is verified using a public key PK 2050, and is generated using a private key corresponding to public key PK 2050.

In some embodiments, a fourth collection (e.g. 2040) can be determined to be a candidate mining attempt for closing a ledger including the ledger entries included in a third collection (e.g. 2030) by determining that a public key (e.g. 2050) satisfies a candidate requirement related to a first challenge (e.g. C2 2016). The first challenge can be computed from ledger entries related to a first collection (e.g. 2010). The first collection can have been incorporated into a ledger prior to a previous closing of the ledger, where the previous closing was based on a previous successful mining attempt associated with a second collection (e.g. 2021).

In various embodiments the candidate requirement can be a requirement that a combination of a public key (e.g. PK 2050) and a challenge (e.g. C2 2016) satisfy a rule. A combination can be a hash function applied to a concatenation, a concatenation, a XORING, or any other suitable combination. A rule can require that the combination matches a target. For example, the rule can require that a hash of the combined public key and challenge end in twenty zeros, or that the Hamming distance between a pre-set 80-bit portion of public key and a pre-set 80-bit portion of the challenge is less than 40 bits. As can readily be appreciated, requirements utilized during mining processes largely depend upon the requirements of specific applications.

In a number of embodiments, selecting between two or more candidate mining solutions can be based on a quality value. A quality value can be computed for each candidate mining solution. A candidate mining solution can be a mining solution that satisfies a candidate requirement. The quality value can be determined based on a public identifier (e.g. public key) and the challenge. For example, a quality value can be determined based on the additive difference between a pre-set 80-bit portion of public key and a pre-set 80-bit portion of a challenge. The successful mining solution can be selected from among the candidate mining solutions based on the quality values associated with the candidate mining solutions. In several embodiments, a mining solution with the highest quality function is selected. A person of skill in the art will recognize that alternative quality functions can be used, and that alternative functions for the candidate requirement can also be used. Moreover, the candidate requirement can be removed altogether, and the quality function used for selection.

In some embodiments, a challenge can be generated based on a cryptographic hash function (e.g. SHA256) of the entries included in a collection (e.g. collection 2010). A challenge can be used to select one or more candidate mining solution winners, where a winner corresponds to a mining solution that has the highest quality measure among those that are submitted as candidate mining solutions. Each candidate winner can correspond to a public key and a private key. The private key can be used to close the ledger by generating a digital signature.

In various embodiments, the challenge can be computed based on a first collection of ledger entries, where the first collection has been already closed. The first collection can have been closed by the signature of a selected public key corresponding to a second collection. Determining the challenge based on an already closed collection avoids the problem of grinding attacks in which a miner may submit entries to the ledger to cause its public key to be selected as a candidate winner.

In several embodiments, a delay function, which can be implemented as a form of proof, controls the pace of ledger closing. The pace at which the ledgers are closed can be governed by a parameter specifying what constitutes a valid response to the delay function. The delay function response can be incorporated with the digital signature used for closing the ledger. The delay function response can be publicly verifiable. The delay function can be based on various proof types. In some embodiments the delay function can be based on a memory-bound proof of space graph problem, as disclosed in U.S. patent application Ser. No. 16/743,503 titled “Robust and Secure Proof of Space Based Mining”, which is hereby incorporated by reference in its entirety.

In many embodiments, a delay function result (e.g. D2 2044) can be a moderately difficult proof-of-work instance that is generated from a collection (e.g. collection 2030) or portions thereof. For example, if V is a value that represents collection 120, then hash(V,D2) can be computed and evaluated. In this example, D2 2044 is the response, and a valid response is a value D2 2044 that causes, for example, the fifteen least significant bits of hash(V,D2) to be zero. This is a moderately hard effort, as it typically requires on average 2\hat{ }15 tries to achieve. In various embodiments a valid delay function response can be determined based on comparing the response to a target. The target can require a number of least significant bits to be zero. The target can have various requirements as can be appreciated by one skilled in the art. As can readily be appreciated, the specific delay function that is utilized is largely dependent upon the requirement of particular applications.

In a number of embodiments, the delay function result can be only computed by processes that determine that a quality value meets a requirement. The requirement can be that a quality value meets a candidate requirement. The requirement can be that a quality value is above a threshold set by the mining operator. The threshold can indicate when it is worth submitting a candidate mining attempt. In certain embodiments, the threshold can be determined based on a number of certified public identifiers, or other criteria such as (but not limited to) the metrics described herein.

The processes described above for avoiding grinding is applicable to at least cryptographic systems utilizing proof of space mechanisms, proof of work mechanisms, TEE-based cryptographic systems, DRM-based cryptographic systems, and composite cryptographic systems.

In a number of embodiments, a mining process can generate a token by submitting a candidate mining solution. The candidate mining solution can include a proof, a public key and an optional digital signature. The proof can include a data string providing evidence that the miner has access to data that matches a challenge generated at least in part from ledger data.

In certain embodiments, the proof can be a solution to a proof-of-work instance related to the challenge. In several embodiments, a proof can include one or more nodes in a graph that is associated with a proof of space, and for which the graph has been registered (e.g., by a commitment related to a value of the graph, said commitment having been posted to the ledger).

In some embodiments, a proof can be a digital signature or other cryptographic proof of knowledge of a value such as a private key. The private key can be associated with a public key or other public identifier. Such a proof can provide evidence of knowledge of the private key matching a public key that satisfies a requirement related to the challenge. The public key and challenge can be used to generate a quality value. The public key may be associated with a TEE, with a DRM, with a phone or with an organization that has been granted the ability to operate a miner.

While specific processes for generating a mining attempt based on a public identifier and a challenge for grinding avoidance are described above, any of a variety of processes can be utilized to generate a mining attempt based on a public identifier and a challenge for grinding avoidance as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generation and verification of a mining attempt based on a certified public identifier, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, mining supervisors, metrics for cryptographic systems, and outsourcing graph generation for cryptographic systems as described elsewhere herein.

### Mining Supervisors and Metrics for Cryptographic Systems

Existing cryptocurrency solutions, such as Bitcoin and Ethereum, demand a tremendous amount of energy as a result of the proof-of-work consensus algorithms. In some embodiments, one or more computing elements (e.g. mining supervisors) are capable of monitoring the various requests for mining and the available mining supplies. These elements can also monitor the various costs of mining which may include (but are not be limited to) electrical energy costs, equipment cooling costs, and political costs. Political costs can include mining in undesirable foreign countries or with highly centralized systems that users may perceive as harming the intent of what is designed to be a highly decentralized cryptocurrency system.

In various embodiments, mining supervisors, can be capable of calculating the resource requirements, or costs, of one or more mining requests. The mining supervisors can report back to a user or process with a cost estimation, or the mining supervisor may be directly involved in gaining cost approvals from the user prior to mining and then directing the mining operation upon approval. In several embodiments, a mining supervisor may have control over many facets of a mining operation implementation. The facets controlled by a mining supervisor can include (but are not limited to) where the mining operation is, when mining occurs, the urgency or the priority of the mining request, and even what type of equipment the mining is to be performed with. In some embodiments, a user with a non-urgent mining request may require that the mining be performed responsibly and only with under-water, self-cooled, mining equipment. In various embodiments, the user may demand the request only be processed when the miner is willing to accept a maximum fee. In several embodiments, the user may demand that the mining be performed by a set of independent miners that are not part of a pooled mining operation or consortium. In certain embodiments, the user may demand that the mining be performed on a weekend when the world's peak energy demands are often at their lowest. In many embodiments, the user may demand the mining be performed only with a renewable primary electrical source such as wind, solar, or hydroelectric power. The mining supervisors can rely on metrics for providing information to miners.

In various embodiments, a process can determine one or more metrics related to cryptographic systems. In several embodiments the process can determine an energy consumption estimate and/or carbon footprint estimate associated with a collection of miners associated with a cryptographic system.

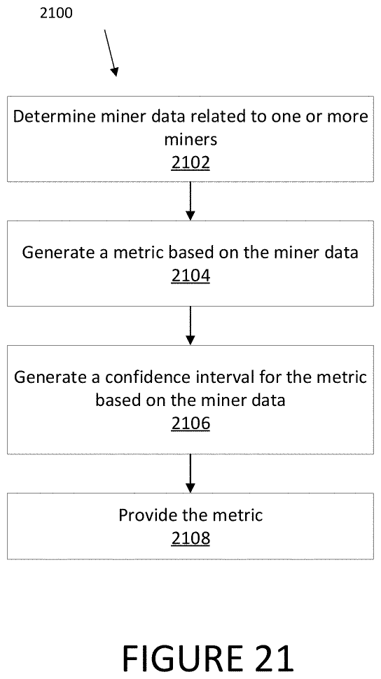

In some embodiments, a process can determine a metric associated with a cryptographic system. In many embodiments the metric can be one or more of an energy consumption metric, an environmental metric, a carbon footprint metric, a geographic distribution metric, and a risk of centralization metric, a resource use metric, an energy mix metric, or another metric. An example of a process for generating a metric associated with a cryptographic system is conceptually illustrated in FIG. 21. In a number of embodiments, processes for generating a metric associated with a cryptographic system can be executed by a computer system.

Process 2100 can determine (2102) miner data related to one or more miners. A metric can be generated (2104) based on the miner data by the process 2100. The metric can be descriptive of a cryptographic system associated with the miners. The confidence interval associated with the metric can be generated (2106) by the process 2100 based on the miner data and provided (2108) to interested systems.

In certain embodiments the metric can be an energy consumption metric associated with the mining of a cryptographic system. In some embodiments the metric can be an environmental metric (e.g. carbon footprint) associated with the mining of a cryptographic system. Miner data can include an estimate of the number of competing miners associated with the cryptographic system. In certain embodiments, the estimate of a number of competing miners can be based on assessing the difficulty of a given length and type of challenge, and by determining the computational complexity of a typical mining implementation on a per-challenge execution. In some embodiments, the miner data can further include an energy consumption per miner. An assessment of a hardware distribution of the likely types of hardware used for mining, and an assessment of the individual energy efficiency of that hardware can be used to determine a device-specific translation between computational effort and energy consumption. In various embodiments, the distribution information can be informed by sales numbers for various types of hardware used for mining, the download of software to use in mining, and indicators associated with submitted responses to mining. The indicators can incorporate information indicating hardware or software platforms. In a number of embodiments, geographic distribution of mining efforts can be determined. The geographic distribution of mining can be determined based on network traffic. For example, the network traffic can be related to public and semi-public bulletin boards (e.g. a mining pool). In many embodiments, the hardware distribution can be weighted based on the geographic distribution determination to determine a likely breakdown of hardware used at a given time, or for a given time period. In certain embodiments, local energy prices can be used with the geographic distribution efforts and the hardware distribution to determine the likely types of hardware and software used for mining on a geographic basis.

In some embodiments, a metric (e.g. an energy consumption metric or an environmental metric) can be determined based on an energy mix associated with the geographic location where mining is performed. An energy mix metric for a cryptographic system can be determined based on the quantities of energy estimated to be consumed in an associated geographical region according to source (e.g. renewable, non-renewable, natural gas, hydro-electric, wind, solar, nuclear, and others), and on geographic distribution of mining. In various embodiments, a differentiation can be made based upon climate factors associated with a geographic location of miner. In a number of embodiments, climate models can be used to determine heating and air conditioning energy requirements associated with a mining operation—these energy requirements can be used to determine one or more metrics associated with a cryptographic system.

In various embodiments, one or more processes associated with generating cryptographic system metrics can be accessible using an API. In a number of embodiments, a user can access metrics and associate these with the sales of products. In several embodiments, the metrics are accessible using a GUI by users.

In certain embodiments, a composite cryptosystem can be adjusted, via configuration parameters, based on one or more metrics. U.S. patent application Ser. No. 17/806,060 titled “Composite Cryptographic Systems with Variable Configuration Parameters and Memory Bound Functions,” which claims priority to U.S. Provisional Patent Application Nos. 63/228,803, 63/228,065, 63/224,345, and 63/208,374, is incorporated by reference in its entirety. The co-pending application describes composite cryptographic systems and varying configuration parameters.

In some embodiments, a metric can be sent to a user (and optionally displayed by a GUI) when a user prepares to send a transaction using a cryptographic system. The metric can, for example, show how much energy is consumed by sending the transaction, or can show how large the carbon footprint associated with the transaction is. This process can guide users and service providers towards low-impact solutions. The displayed metric can be a scaled metric. A scaled metric can be a metric (e.g. an energy consumption metric) corresponding to the user's transaction (e.g. estimated energy usage associate with the transaction).

In many embodiments, one or more metrics can be associated with a risk of imbalance or centralization. An imbalance may arise, for example, from 51% attacks, and the risk of such attacks can depend on an assessment of geographic distribution of mining and the potential control a single entity, such as a government, may have on the mining of a given cryptocurrency. A process can determine relative risks using models and simulations based on one or more assumptions about the risks. The assumptions can be combined with geographic and other distribution data.

Various embodiments can determine a concentration metric (e.g. software concentration, or hardware concentration). A concentration metric can be based on a percent of mining that is completed during a time period (e.g. a day) that can be associated with a first type of platform (e.g. software or hardware). If the concentration metric exceeds a threshold (e.g. 50%, or 51%) this can be an indication of a high risk that a 51% attack can be mounted on the network. For example, the network may be at risk of a 51% attack by manipulation or infection of the first type of platform, where manipulation may take place in the form of a network-wide patch event. In contrast, if no platform has a greater distribution than 5%, this can be an indication of a much lower risk for such an event. In certain embodiments, using assessments and simulations, metrics (e.g risk scores) associated with various abuses can be computed, informed by knowledge associated with hardware type, software type, geopolitical oversight possibilities, assessments of likely geographic location, and more. In some embodiments, a risk score exceeding a threshold can cause distribution of software protection to guard against certain types of malware. U.S. Provisional Patent Application No. 62/812,901 titled “Fair and Affordable Mining” by Bjorn Markus Jakobsson is incorporated by reference in its entirety.

In several embodiments, metrics related to the use or consumption of resources can be computed. In various embodiments, metrics related to the amount of storage resources dedicated to mining can be generated. Metrics related to computational resources used in mining can be generated. In various embodiments, metrics related to a scarcity of resources (e.g. storage capacity, or computational capacity) can be indicative of a vulnerability of a cryptographic system to attack. In certain embodiments, metrics can be used by a miner to make automated scaling decisions, such as the decision to instantiate a new proof-of-space mining graph.

In various embodiments, correctness controls can be used to statistically verify the accuracy of the estimate. Statistically verifying the accuracy of the estimate can include determining an associated confidence level or variance associated with the assessed metric. As can readily be appreciated the specific correctness controls utilized within a cryptographic system are largely only limited by the requirements of a given application.

In several embodiments, a process can present the metric in various ways. In many embodiments the metric can be presented on a per-coin basis. A metric can be determined on a per-circulating coin basis based on a circulating supply of a coin. A metric can be determined on a per-total coin basis based on a total supply of a coin. A coin can refer to a token generated, represented, transferred, or otherwise hosted by a cryptographic system.

In certain embodiments, the metric can be presented on a per-dollar basis. The per-dollar basis can be a scaling of the per-coin basis. The scaling can include dividing a per-coin metric by an average market price of the coin during the time interval being assessed.

In some embodiments, the metrics generated can be related to a composite cryptographic system. Metrics can be generated for each constituent cryptographic system within the composite cryptographic system. The metrics can be used to determine one or more configuration parameters associated with a composite cryptographic system and/or its constituent cryptographic systems.

In certain embodiments, a DRM-based mining system can be used to identify abuse. Identifying abuse can include identifying that a given miner is operating in a virtual machine (VM). Miners operating in a virtual machine (VM) may wish to trick their mining applications to believe that the miner is not operating in a VM. In various embodiments, if a mining application identifies that a miner is operating in a VM, the mining application can modify its operation. The modification can include ceasing operations or reducing the probability of mining success. This is a similar situation to how anti-virus filters commonly wish to contain potential viruses and other malware in VMs, where they are evaluated based on their execution behavior, whereas the virus or other malware instead wants to detect its presence in a VM, and thereby operate only in an innocuous manner in such environments, thereby avoiding detection. Thus, mining applications can be built based on insights developed by virus and malware developers, creating a virtuous benefit out of their attempts to abuse.

While specific processes for generating a metric associated with a cryptographic system are described above, any of a variety of processes can be utilized to generating a metric associated with a cryptographic system as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generation of one or more metrics associated with a cryptographic system, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, mining supervisors, metrics for cryptographic systems, and outsourcing graph generation for cryptographic systems as described elsewhere herein.

In many embodiments, the metrics disclosed herein, can be used to control configuration parameters. In a number of embodiments, configuration parameters governing the difficulty of a proof of work, a delay function, a proof-of-space instance, and more, can be governed by values. The values can be computed by distributed parties, such as miners. The values can be based on the metrics disclosed herein, among other things. For example, a parameter determining the difficulty of a task can be set so that the difficulty increases as the speed of closing ledger entries increases. As the difficulty increases, the speed of closing ledger entries may decrease. In another example, a configuration parameter can be set to depend on the energy consumption estimates from public sources of information, the local miner's time of day and corresponding peak energy production costs, and/or on the trading price of a coin. This type of feedback loop, disclosed in U.S. Provisional Patent Application No. 63/210,040 titled “Content Recommendation Method” can be used in the context of the disclosed technology, and is incorporated by reference in its entirety.

In some embodiments, a mining supervisor can be assembled in a decentralized manner within a given cryptographic, blockchain, ledger, and/or distributed ledger system. In various embodiments, the mining supervisor can be assembled with an external system whereby the mining supervisor and cryptographic system process form a composite structure. In some embodiments, a public ledger record can indicate mining preferences associated with a given ledger entry. For example, a ledger entry can list the requirements set by a user. In some cases, the public ledger can include a “responsible mining” indication for a given ledger entry.

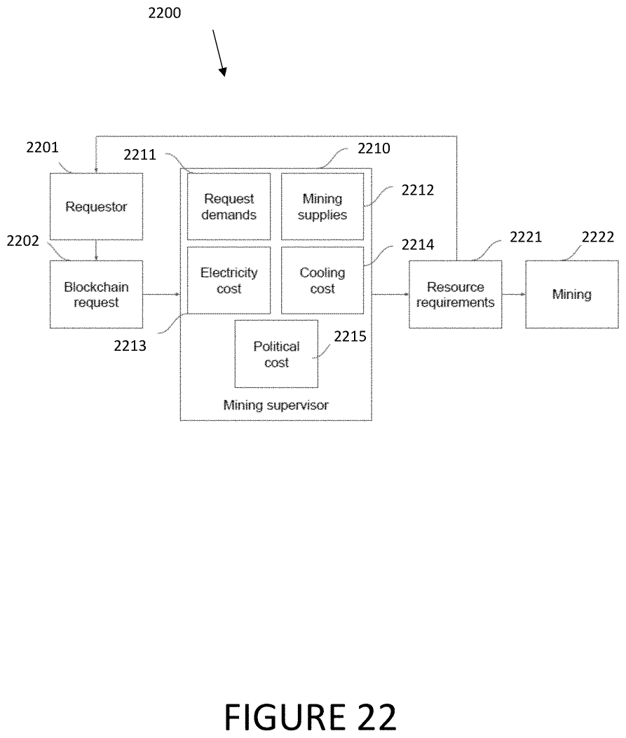

An example mining platform that provides resource information to a requestor prior to initiating a mining operation is conceptually illustrated in FIG. 22. The mining platform 2200 includes a requestor 2201, a mining supervisor 2210, and a mining operation 2222. The requestor 2201 initiates a blockchain request 2202. The blockchain request 2202 can be received by the mining supervisor 2210. The mining supervisor 2210 can access information from a mining marketplace and can have real-time mining supply and demand data related mining request demands 2211 and mining supplies 2212. Additionally, the mining supervisor 2210 can have access to data related to electricity cost 2213, cooling cost 2214, and/or political cost 2215. The data available to the mining supervisor 2210 can include the metrics described herein. In some embodiments, the political cost 2215 may, for example, include mining supply information for particular countries and may include the perceived cost of using centralized mining resources. Mining supervisor 2210 is capable of determining the resource requirements 2221 for the blockchain request 2202. The resource requirements 2221 can be based on the data available to the mining supervisor 2210 and the blockchain request 2202. The mining supervisor can send the resource requirements 2221 to the requestor 2201. The resource requirement 2221 can be received by the requestor 2201 before the mining operation 2222 commences. The mining operation 2222 is shown as not gated by the mining supervisor 2210. In various embodiments, a mining operation can be gated by a mining supervisor. In certain embodiments, a mining operation can be not gated by the mining supervisor. In some embodiments, the mining operation 2222 initiates regardless of the resource requirements 2221.

Various alternatives to the depicted example are possible. For example, the mining supervisor can report back to the requestor 2201 for informational purposes or can be involved in the blockchain request 2202 flow. As can readily be appreciated, any of a variety of processes for providing resource information concerning a cryptographic system can be utilized as appropriate to the requirements of specific applications in accordance with various embodiments of the invention.

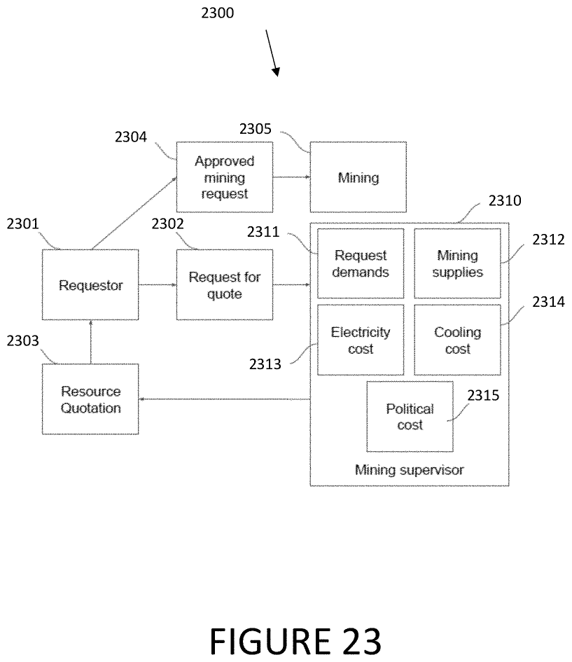

An example mining platform that provides resource information to a requestor prior to the requestor approving a mining operation is conceptually illustrated in FIG. 23. In the illustrated embodiment, the mining platform 2300 includes a requestor 2301, a mining operation 2305 and a mining supervisor 2310. The requestor 2301 issues a request for a quote 2302 to the mining supervisor 2210. The request for a quote can be issued prior to issuance of an approved mining request 2304. The mining supervisor 2310 can access information from a mining marketplace and can have real-time mining supply and demand data related mining request demands 2311 and mining supplies 2312. Additionally, the mining supervisor 2310 can have access to data related to electricity cost 2313, cooling cost 2314, and political cost 2315. The data available to the mining supervisor 2310 can include the metrics described herein. The mining supervisor 2310 is capable of determining the resource requirements for a blockchain request received with a request for quote 2302. The mining supervisor sends a resource quotation 2303 to the requestor 2301. Based on the received resource quotation 2303 the requestor 2301 can an approved mining request 2304 for execution of mining operation 2305. FIG. 23 represents an example whereby mining supervisor 2310 is not directly involved in the approved mining request 2304 and mining operation 2305. As can readily be appreciated, other approaches can also be utilized in accordance with requirements of specific applications.

In various embodiments, the requestor, mining supervisor, and/or mining operation can be processes. The requestor may be executed on a first computer system, the mining supervisor on a second system, and the mining operation on a third system. In some embodiments, the first system can be the same as the second system. In some embodiments, the second system can be the same as the third system. In many embodiments, the third system can be the same as the first system. In many embodiments, the requestor, mining supervisors, and/or mining operation can communicate over a network.

In some embodiments of a mining platform, a mining supervisor can approve a mining request for execution of a mining operation. In various embodiment s the execution of a mining request can be based on rules and metrics available to a mining supervisor.

While specific processes mining supervisors providing information to requestors are described above, any of a variety of processes can be to provide information to requestors as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to obtaining and transferring information related to a cryptographic system, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, mining supervisors, metrics for cryptographic systems, and outsourcing graph generation for cryptographic systems as described elsewhere herein.

### Outsourcing Graph Generation

Several cryptosystems, such as the system described in “Fair and Affordable Mining” by Markus Jakobsson; in the Chia™ cryptosystem, as described on https://www.chia.net/faq/; and the BurstCoin™ cryptographic system, address energy efficiency; all of these documents are incorporated by reference. However, one aspect that is common for all of these cryptosystems is that they are associated with a substantial initial energy cost, associated with the setup of a particular miner.

The initial energy cost can be associated with the computation of a graph including a set of nodes and edges. The graph can be later used to generate responses to challenges. A mining instance (also referred to as a mining attempt, or mining solution) can be associated with the graph. A mining instance can be associated with an identifier that is used for registration of the graph. In some embodiments, the identifier may be the root of a Merkle tree. The identifier can be associated with a public key by being a function of the public key, where this function may be associated with the application of one or more cryptographic hash function evaluations. The public key can be associated with a secret key. The secret key can be used for transfer of rights. In some embodiments, the public key may be a Merkle root and the associated secret key may comprise a collection of leaf values used to compute the Merkle root, using a Merkle tree structure of iterated hashing of tuples. In various embodiments, the public key may be an RSA public key from which the identifier used in registration is computed. The associated private key can be the associated RSA private key.

In several embodiments, the generation of a graph is at least in part outsourced by a miner (e.g. a miner process executed by a system), to a generator (e.g. a generator process executed by a system) that can compute the graph in a more efficient or less costly manner than the miner. The generator may have access to lower energy costs, a cooler climate, special-purpose computational equipment, and more. In some embodiments, the generator can be a third party can be a generator. In some embodiments the generator may not be a third party. In various embodiments, a generator process can be executed by the same system as a miner process.

However, whereas the mining entity may trust this third party, which we refer to as the generator, to correctly generate one or more graphs, the mining entity may not trust that the mining entity would not attempt to sell this graph to multiple buyers, including the mining entity. If this were to happen, it would lead to a situation in which these different buyers of the graph would have a disadvantage in comparison to other miners, as each one of them would have to race the others in order to succeed with a mining attempt. Accordingly, while it is beneficial for mining entities to outsource computationally demanding computation to generators, this can be undesirable due to the risk associated with this type of potential abuse. This problem is addressed herein.

In some embodiments, a mining entity (e.g. miner, mining process) generates a key pair comprising a private key and a public key. The miner safekeeps the private key. The miner can transmit the public key to a generator (e.g. a generator process). The generator can generate a graph based on or associated with the received public key. Once generated the graph can be verified by the generator. The generator can transmit the graph to the miner.

In various embodiments, the miner can receive the graph. The miner can use the graph for purposes of mining. Other parties given access to the same graph cannot use the graph for mining as these other parties do not have access to the associated private key.

In several embodiments, at least one of the nodes of the graph is derived from the public key provided by the miner. Requiring that at least one node of the graph is derived from the public key can guarantee that one graph cannot be successfully associated, by a cheating generator, with two or more public keys.

In certain embodiments, the miner can verify that the generator derived at least one node from the public key by verifying the composition of the graph. In some embodiments, the generator creates a graph using the public key as one part of a seed that is used as an input to the generator's pseudo-random generator (PRG). In various embodiments, the generator can embed the public key in every node value by making a first node value a keyed hash of the nodes that are connected by edges to the first node. The keyed hash can use a cryptographic hash function such as SHA256. Each use of the hash function can involve the public key as a key. For example, when computing the hash of a value V1 using this method, the computation can be SHA256(PK, V1), where PK is the public key to be associated with the graph. This association is publicly verifiable, and any party verifying a candidate mining solution can automatically associate the mining solution with the public key. Only a party with knowledge of the associated private key, which the miner has, but no other party has, can be able to generate a digital signature that is verified using this public key. Moreover, a miner and a generator that do not trust each other with the exchange of the graph for the payment of the graph can use an exchange mechanism. A suitable exchange mechanism is described herein. In various embodiments, the exchange mechanism described can be used for a fair exchange in the context disclosed herein, including for use as a payment for outsourced generation of graphs and for purposes of exchanging payments for contracts without the need for any trust. Exchange methods are also disclosed M. Jakobsson, “Ripping Coins for a Fair Exchange,” Advances in Cryptology—Proceedings of Eurocrypt '95, pp. 220-230 which is incorporated by reference in its entirety.

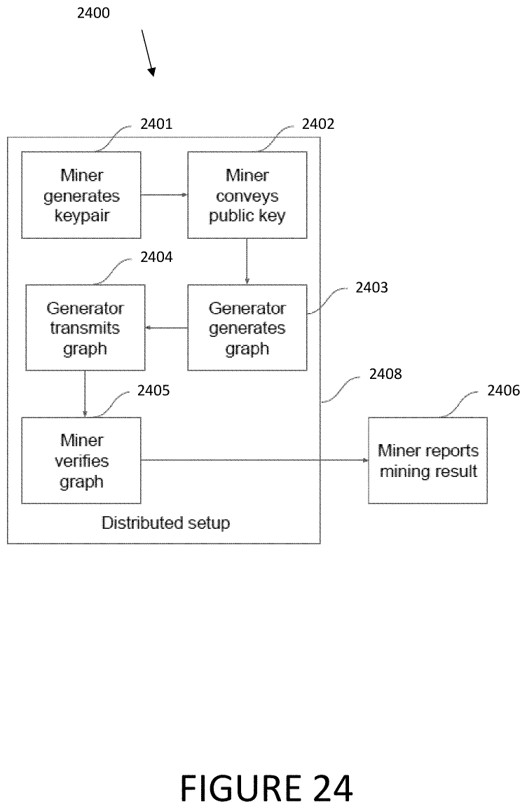

In several embodiments a cryptographic system with a proof-of-space mechanism can be used with a public identifier. The public identifier can be a public key. The public identifier can be associated with a TEE, DRM or other system as previously described. In various embodiments a first process can send a public identifier (e.g. public key) to a resource and receive a graph based on the public identifier. The first process can then use the graph and the public key to generate a mining attempt. The received graph can be an outsourced graph. The outsourced graph can be computed by a second process based on the public identifier. An example process for generating a mining attempt based on a public identifier and a received graph is conceptually illustrated in FIG. 24.

A process 2400 includes a distributed setup 2408 and reporting of a mining result 2406. The reported mining result can be related to the graph generated in the distributed setup 2408. A mining process can generate (2401) a keypair. The keypair can include a public key and a private key. As described elsewhere herein the private key can be stored in a TEE, stored with a DRM system, associated with the cellphone, and/or otherwise certified.

The mining process can convey (2402) the public key and other data (e.g. a commitment) to the generator process. The mining process and the generator process may be on the same or different computer system. The generator process can receive the public key. The generator process can generate (2403) a graph based on the received public key. In various embodiments, generating the graph based on the public key can be computationally intensive. In several embodiments, the generator may require a commitment to a payment prior to generating the graph. A process for a commitment to payment is described elsewhere herein. The commitment can be part of the data conveyed (2402) by the mining process. In many embodiments, the generator process can verify the received commitment prior to generating the graph. The generator process can convey the generated graph to the mining process. The mining process can receive the generated graph. The mining process can verify (2405) at least portions of the graph received. In several embodiments, verifying the graph can include determining that the graph is well formed, that the graph is associated with the appropriate public key, and/or that the graph complies with any other requirements, such as having a specified size. The mining process can use the graph for mining. The mining process reports (2406) mining attempts to a ledger. The mining process can include mining as described elsewhere herein. The graph and mining described can relate to a proof-of-space mechanism, or similar mechanism relying on a graph or table.

While specific processes for generating a mining attempt based on a public identifier and a received graph are described above, any of a variety of processes can be utilized to generate a mining attempt based on a public identifier and a received graph as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generation and verification of a mining attempt based on a received graph and a certified public identifier, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, mining supervisors, metrics for cryptographic systems, and outsourcing graph generation for cryptographic systems as described elsewhere herein.

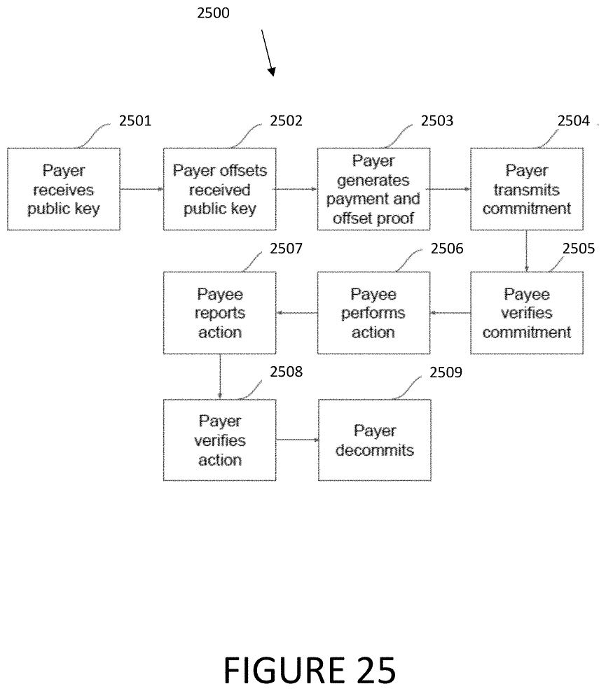

In some embodiments the commitment can be generated by a process. In certain embodiments, a fair exchange mechanism can be used to generate the commitment. The fair exchange mechanism can securely associate a transaction with a verifiable output. The verifiable output can be a graph as previously described. An example process for the committing of payment for the outsourced generation of a graph using a fair exchange mechanism is conceptually illustrated in FIG. 25. In several embodiments the fair exchange mechanism can be related to the outsourcing of graph generation, an example of which is conceptually illustrated in FIG. 24. In many embodiments a fair exchange mechanism can be used for applications not related to the outsourcing of graph generation.

A process 2500 can include a payer process and a payee process. A payer process can receive (2501) a public key P from a payee process. In various embodiments, the payer process can be related to a mining process, such as the mining process described in relation to FIG. 24. In several embodiments the payee process can be related to a generator process, such as the generating process described in relation to FIG. 24.

In some embodiments, the public key P can be a Digital Signature Algorithm (DSA) public key of the format P=g\hat{ }x, where \hat{ } represents modular exponentiation with respect to a prime field that has been set ahead of time. In the example, x is the private key held by the payee process, and not known by the payer process.

The payer process can generate (2502) an offset to the public key P. In various embodiments, the offset to the public key (e.g. P) can be calculated based on the public key and a public offset (e.g. R). The offset to the public key P′ can be generated as P′=P*R. The public offset R can be generated by selecting a random offset secret value y and generating R=g\hat{ }y. The * represents modular multiplication and \hat{ } represents modular exponentiation with respect to a prime field that has been set ahead of time as will be understood by a person familiar with DSA.

The payer process can generate (2503) a transaction (e.g. payment) relative to the offset public key, and a proof of knowledge based on the public offset. In several embodiments the payer process generates a transaction relative to the offset public key P′ and generates a proof of knowledge of the discrete log of R, which is the value y. The proof of knowledge can be a DSA signature generated using the secret key y, and verified using the public key R. The public key R can be computed by the payee process as R=P′/P, wherein/represents modular division, as will be understood by a person familiar with DSA. The message being signed in the digital signature verified using the public key R can be a nonce, or a value related to the payment made relative to public key P′.

The payer process can transmit (2504) a commitment to the payee process. The commitment can include the transaction and the proof of knowledge.

The payee process can verify (2505) the commitment. In several embodiments, the payee process verifies that the transaction is a transaction relative to the offset public key P′. The payee can verify that the proof is a proof of knowledge of the discrete log of P′/P. The transaction can be publicly logged (e.g., on a ledger, on a distributed ledger, on a blockchain). Logging the transaction publicly can prevent the payer process from spending the same funds again to another payee process (e.g. publicly logging the transaction prevents double-spending). In various embodiments, the payee process can have knowledge that that the corresponding funds can only be spent by a party knowing the secret key x+y. However, while the payee process knows x and the payer process knows y, neither party knows x+y. The payee process therefore knows that these funds have been spent by the payer process, and cannot (by virtue of this payment having been recorded) be spent again without detection of double-spending. At the same time, the payer process knows that the payee process cannot spend the funds, as the payee process knows x, but not x+y. This is because both x and y are selected as random or pseudo-random and have not been shared.

The payee process can perform 2506 an action. In some embodiments, this action may include generating a graph, such as described above with respect to FIG. 24. In various embodiments the action can include performing a payment from the payee process of process 2500 to the payer process of process 2500. In some embodiments the payee action can be sending another transaction. The other transaction can be the transfer of a token on the same, or a different blockchain. In some embodiments, the exchange mechanism can be used as to exchange one cryptographic token crypto coin currency for another between two parties, without the need for trust between them. In several embodiments, the exchange mechanism can be used to exchange a payment and a contract associated with the payment.

The payee process can report (2507) to the payer process that the action of step 506 has been taken. In some embodiments, the payee process will convey evidence supporting the completion of the action. For example, the providing evidence may include a graph being transmitted to a mining process.

The payer process can verify (2508) received evidence associated with the action. The verification 2508 can correspond to the verification 2405.

The payer process can decommit 2509. Decommitting can include transmitting the value y to the payee process. The payee process can generate the offset private key x′=x+y, which is the private key associated with the public key P′ of the payment transmitted in commitment 2504. However, the payer process does not know the offset private key x′, as it does not know the value x and cannot generate it from P, based on the discrete log assumption underlying the DSA. This means that the payee process now has the capability of spending the coin associated with the payment of commitment 2504.

In several embodiments of the exchange mechanism, a third party would not be able to tell from observing a payment by the payee process, using P′ as the public key for verifying the payment, that the transfer was part of a fair exchange mechanism and not a traditional transfer.

In some embodiments, a third party may be able to infer the use of the fair exchange mechanism. A third part can verify a payment being made using the offset private key x′ and verified using the offset public key P′.

In various embodiments, the public key in the mining solution can be used to transfer value of an associated token to another party, e.g., by signing a message encoding the transfer of rights to a second public key for which the associated second private key is known by the party to which the transfer is done. The message may also encode an indication of a portion of the value of the token, such as 1/100 of the token, or ¼ of the token. Independently of the market value of the token, this can enable the spending rights of the coin accordingly.

In some embodiments, an algorithm can release portions of a token value with time, as disclosed in U.S. patent application Ser. No. 17/806,065 titled “Perpetual NFT Assets,” which claims priority to U.S. Provisional Patent Application No. 63/208,366, is incorporated by reference in its entirety. A token can also permit transfer only in full, i.e., not in part. The transfer of a token, whether in full or in part, can be governed by a contract that encodes the portion of the value to be transferred; to what party it is to be transferred, and/or any conditions of the transfer. An example condition can be that the original owner has passed away and that this can be verified using some publicly verifiable statement. Such a contract, therefore, encodes a last will. Other contracts encoding conditions can be implemented, where the conditions are machine readable rules. Such machine-readable rules may also have human-readable rules corresponding to and matching in terms of meaning the machine readable rules. This can enable an automation of some traditional contracts, such as deeds, transfer of deeds, employment contracts, and more. Having a machine-readable version of such traditional contract can enable the automated evaluation of conditions, provided publicly-verifiable statements of contexts related to by the contracts. This can further enable a low-cost and automated performing of many tasks that today are handled by attorneys and courts, and an associated improvement in efficiency and cost.

While specific processes for the committing of payment for the outsourced generation of a graph using a fair exchange mechanism are described above, any of a variety of processes for the committing of payment for the outsourced generation can be utilized to generate a mining attempt based on a public identifier and a received graph as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to the outsourced generation of a graph, the techniques disclosed herein may be used in any type of cryptographic system. In particular, the techniques disclosed herein may be used in a system incorporating one of, or a combination of cryptographic systems including Proof of Work, Proof of Space, Proof of Stake, Proof of Bus, or memory bound functions. The techniques disclosed herein may be used within any of the rich media systems, permissioned blockchains, smart contract, mining supervisors, metrics for cryptographic systems, and outsourcing graph generation for cryptographic systems as described elsewhere herein.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

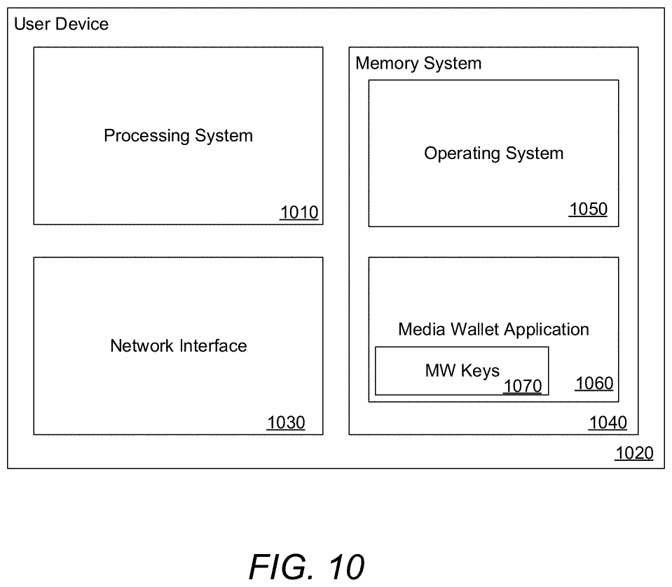

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

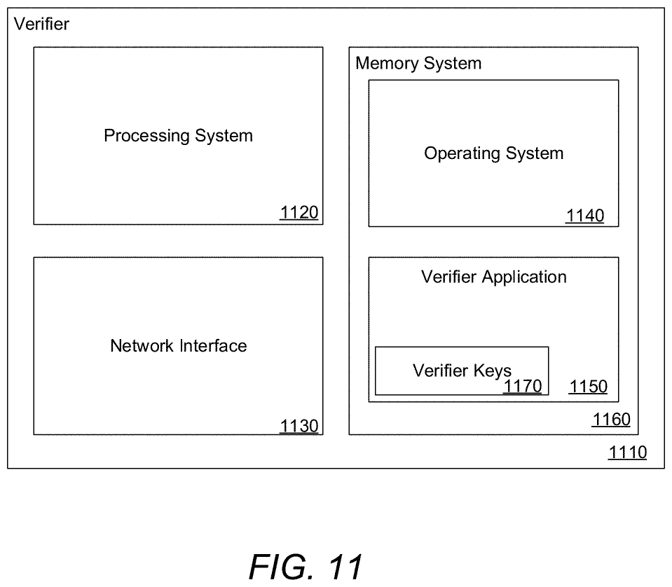

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

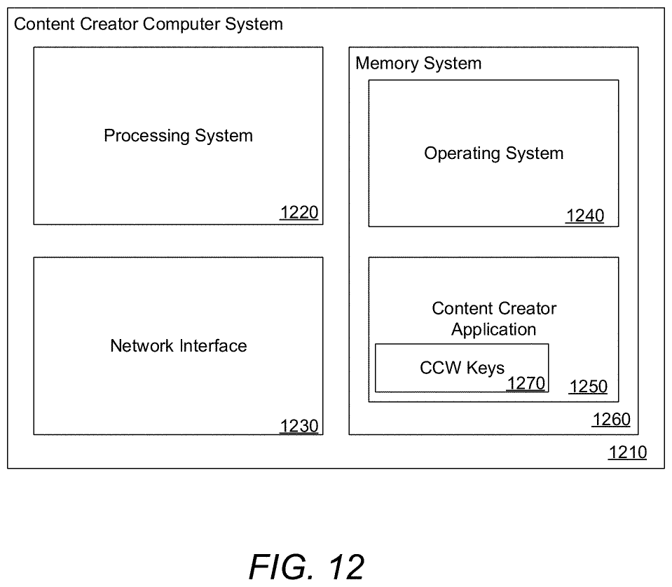

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

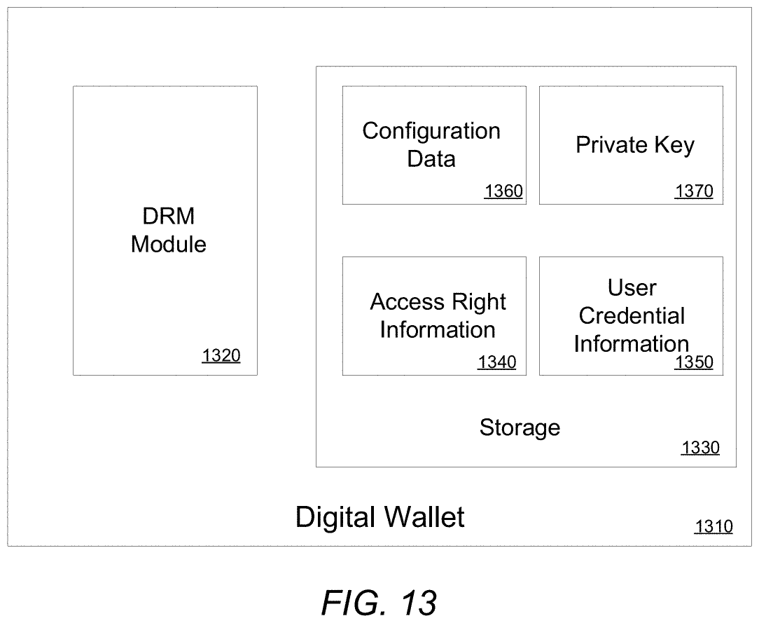

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

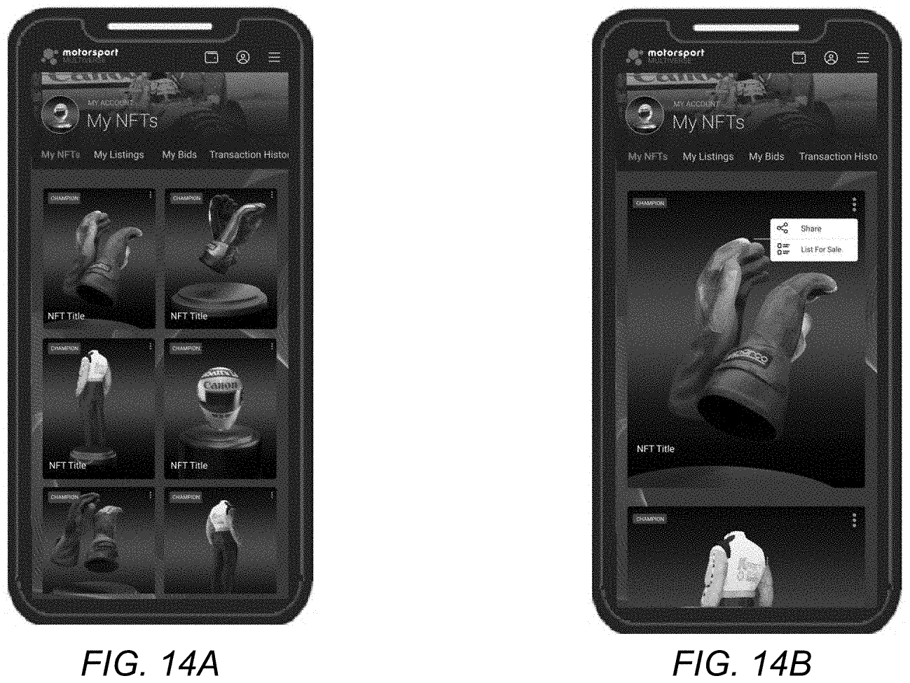

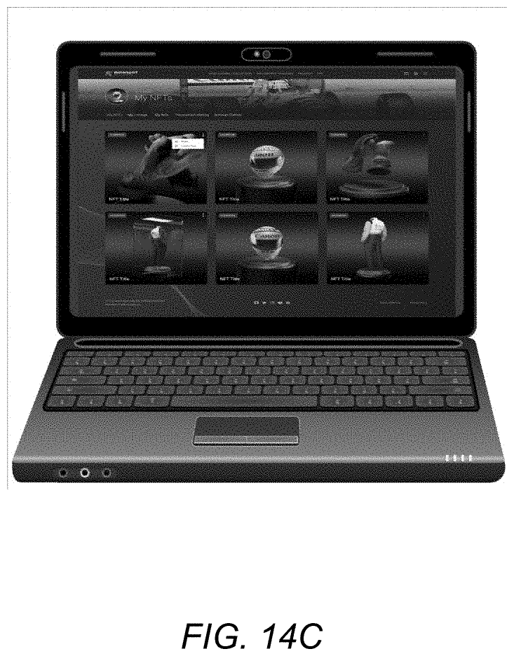

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.”

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

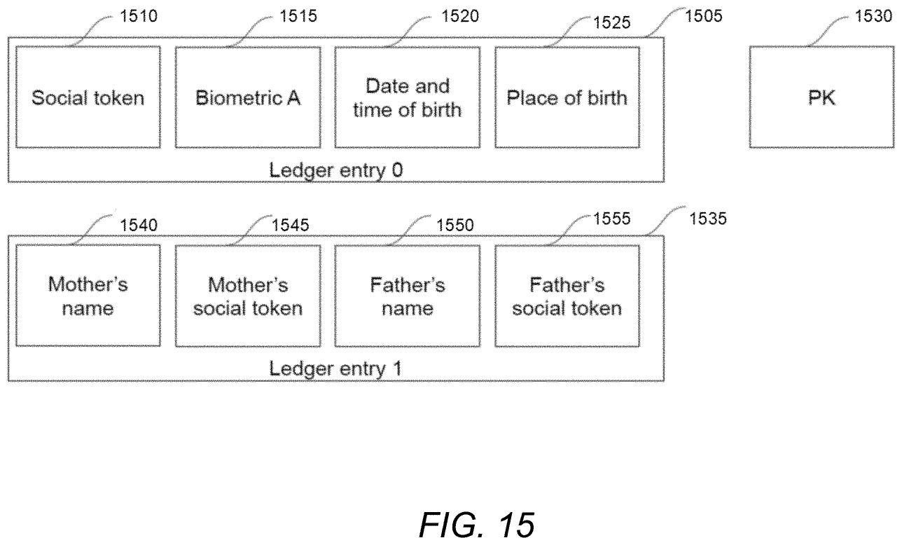

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

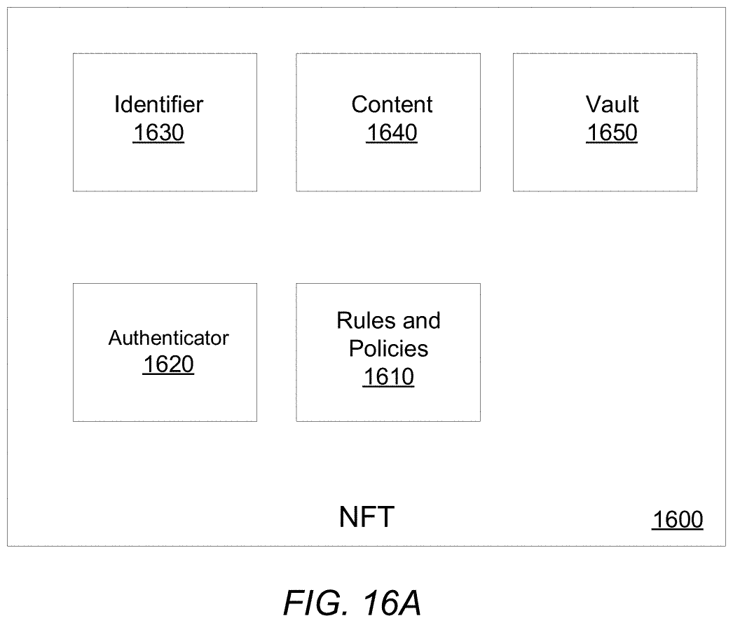

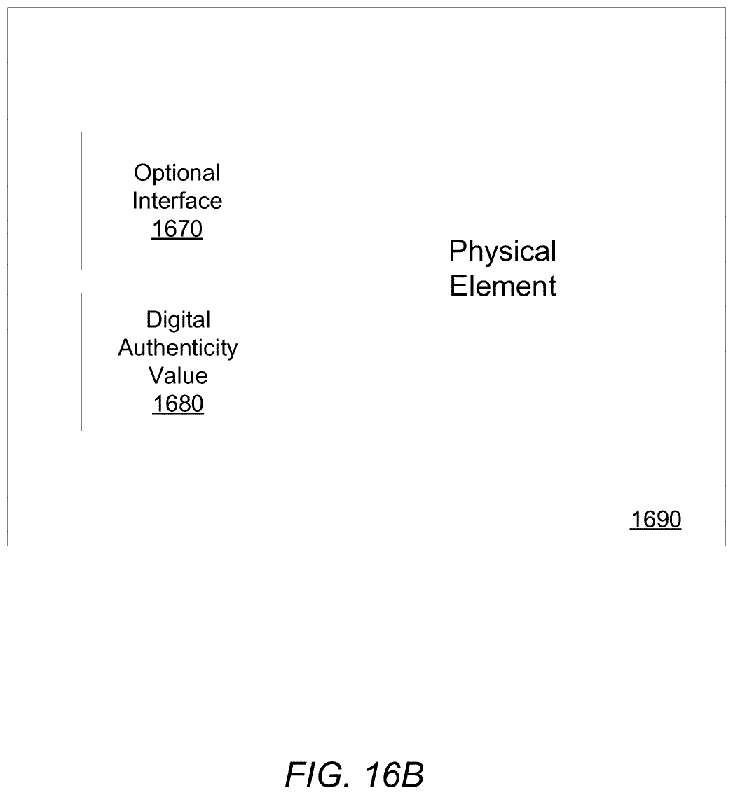

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

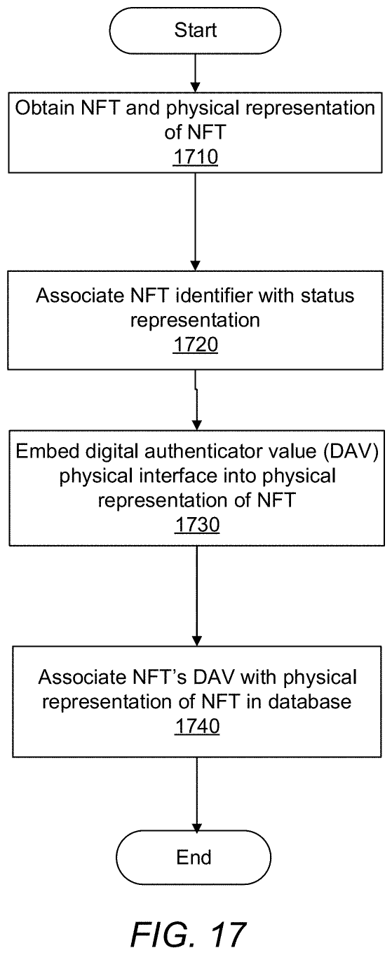

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A device configured to close a ledger maintained by a cryptographic system, the device comprising:
a network interface;
memory; and
a processor, the processor configured to:
obtain a challenge using a cryptographic system, wherein the challenge is based on a first collection of ledger entries on a ledger, the first collection of ledger entries closed based on a first mining attempt;
determine a quality value based on the challenge and a value; and
transmit a second mining attempt to securely close a second collection of ledger entries on the ledger, wherein the second mining attempt is capable of being validated by using the challenge and the cryptographic system.

2. The device of claim 1, wherein the value is a public identifier.

3. The device of claim 1, wherein the value is a public key.

4. The device of claim 3, wherein the mining attempt comprises a digital signature, the digital signature generated using a private key, the private key corresponding to the public key.

5. The device of claim 3, wherein a private key is associated with the public key and the private key is stored in a secure storage associated with a Trusted Execution Environment.

6. The device of claim 3, wherein a private key is associated with the public key and the private key is associated with a certified Digital Rights Management system.

7. The device of claim 1, wherein the mining attempt comprises a delay function result.

8. The device of claim 6, wherein the delay function result is a proof of work.

9. The device of claim 1, wherein the mining attempt is capable of being validated by using the value.

10. The device of claim 1, wherein the processor is further configured to generate a challenge using a cryptographic system, wherein the challenge is based on a closed collection of ledger entries on a ledger.

11. The device of claim 3, wherein the challenge is a hash of at least the first collection of ledger entries and the quality value is based on a hamming distance between the challenge and the public key.

12. The device of claim 1, wherein the challenge is based on a most recently closed collection of ledger entries.

13. A device configured to close a ledger maintained by a cryptographic system, the device comprising:
a network interface;
memory; and
a processor, the processor configured to:
obtain a mining attempt comprising a digital signature, the digital signature generated using a private key associated with a public key;
determine a quality value based on the public key and a challenge; and
transmit the mining attempt to securely close a collection of ledger entries on the ledger, wherein the mining attempt is capable of being validated based on the quality value and the public key.

14. The device of claim 13, wherein the mining attempt further comprises a delay function result.

15. The device of claim 13, wherein the delay function result is a proof of work.

16. The device of claim 13, wherein the challenge is based on a closed collection of ledger entries.

17. The device of claim 13, wherein the mining attempt comprises a digital signature, the digital signature generated using a private key, the private key corresponding to the public key.

18. The device of claim 13, wherein the private key is stored in a secure storage associated with a Trusted Execution Environment.

19. The device of claim 13, wherein the private key is associated with a certified Digital Rights Management system.

20. The device of claim 13, wherein the challenge is based on a most recently closed collection of ledger entries.
